(19) United States
(12) Patent Application Publication
(10) Pub. No.: US 2015/0332371 A1
(43) Pub. Date: Nov. 19, 2015

(54) A Method For Ranking A Plurality Of Real Properties On Offer And A System For Ranking A Plurality Of Real Properties On Offer

(71) Applicant: MPMSYSTEMS PTY LTD, Tuggerah (AU)

(72) Inventor: Reuben LOMAS, Tuggerah (AU)

(21) Appl. No.: 14/646,387

(22) PCT Filed: Dec. 18, 2013
(86) PCT No.: PCT/AU2013/001485

§ 371 Date: May 21, 2015

(30) Foreign Application Priority Data
Dec. 20, 2012 (AU) 2012905584

(51) Int. Cl. G06Q 30/06; G06F 3/0484; G06F 3/0482; G06F 17/30

(52) U.S. Cl. CPC G06Q 30/0625; G06F 17/30241; G06F 3/04842; G06F 3/0482; G06Q 50/16

(57) ABSTRACT

Disclosed herein is a system (10) for determining the compatibility of a purchaser with a plurality of real properties on offer. The system (10) is arranged to exclude those of the plurality of real properties on offer that match at least one exclusion criterion. The system (10) is arranged to use a plurality of characteristics to generate, for each of the non-excluded ones of the plurality of real properties on offer, a property compatibility index. Each property compatibility index is indicative of a degree of compatibility between the corresponding real property and the purchaser. The plurality of characteristics comprise at least one characteristic of the purchaser and at least one characteristic of each of the non-excluded ones of the plurality of real properties on offer.

### TECHNICAL FIELD

The disclosure herein generally relates to technology for comparing real properties available for purchase.

### BACKGROUND

Real property, also known as real estate, is bought for many reasons, including personal use, commercial use and investment purposes. Property has traditionally been an attractive form of investment for individuals, but property investors range from individuals to corporations and institutions of all sizes.

A property investment may be the largest single investment an individual may ever make. Therefore, it is important to choose a property investment carefully.

There are significant expenses associated with purchasing a property, including building inspection fees, government stamp duties, insurance premiums, conveyancing fees, legal fees and loan fees. There are also significant expenses associated with selling a property, including advertising fees, legal fees, and agents' fees. The buying and selling processes may each take months to complete and may involve coordinating multiple parties and holding numerous discussions and negotiations. There are also significant costs in holding a property, including rates, loan interest, repairs and maintenance. Therefore, it is important to take great care when selecting a property to be purchased.

Unfortunately, the process of selecting a property that meets the specific requirements of a purchaser may be time consuming and may be beyond the skills of the purchaser. One reason it may be difficult to select a suitable property is that there may be large numbers of properties available which need to be compared with each other. Also, there may be a large number of factors to be considered for each property. When there are a large number of properties to be compared and a large number of factors to be considered, it may become extremely difficult to weigh up and evaluate the pros and cons of all the properties.

Another reason it may be difficult to select a suitable property is that each property generally has a unique combination of features and benefits. Some of those features and benefits may be based on the dwelling itself, for example the number of bedrooms, floor area, quality of fixtures, ventilation, noise levels etc. Other features and benefits may be based on the area in which the property is located, for example capital growth of the area, market demand for rental properties in the area, desirability of the area, or proximity to public transport, schools, shops, entertainment, sources of employment etc. The combination of features and benefits such as these tend to make each property unique in some way, and this uniqueness may make it difficult to compare properties with each other.

Another reason it may be difficult to select a suitable property is that the investment preferences and requirements of each property purchaser tend to be different due to differing personal circumstances. A property that is very suitable for one purchaser may be entirely unsuitable for another purchaser with different circumstances. For example, a younger property investor with a high income may prefer to purchase properties predicted to undergo large capital growth but have a low rental yield. On the other hand, a retired property investor may prefer to invest in property with a high rental yield but is less reliant on capital growth. Such purchaser-related factors add to the difficulty in selecting a property.

### SUMMARY

Disclosed herein is a method for determining the compatibility of a purchaser with a plurality of real properties on offer. The method comprises excluding those of the plurality of real properties on offer that match at least one exclusion criterion. The method comprises using a plurality of characteristics to generate, for each of the non-excluded ones of the plurality of real properties on offer, a property compatibility index indicative of a degree of compatibility between the corresponding real property and the purchaser. The plurality of characteristics comprises at least one characteristic of the purchaser and at least one characteristic of each of the non-excluded ones of the plurality of real properties on offer.

For example, the purchaser may be a real property investor. In another example, the purchaser may be a home buyer.

The method may help property purchasers to consider and evaluate more factors relating to the compatibility of a property with at least one of their preferences and circumstances. The method may inform purchasers before making a property purchase, which may reduce the risk of a purchaser wasting time and money on a property that does not adequately suit their needs. The method may help purchasers save time when selecting a property.

In an embodiment, the plurality of characteristics further comprises loan qualification characteristics indicative of a probability that the purchaser will qualify for finance for each of the non-excluded ones of the plurality of real properties on offer.

An embodiment comprises the step of a processor interface of a processor receiving purchaser data indicative of the at least one characteristic of the purchaser. Property data indicative of the at least one characteristic of each of the plurality of real properties may be received by the processor interface. An index generation module of the processor may generate the property compatibility index for each of the non-excluded ones of the plurality of real properties on offer, the property compatibility index for each of the non-excluded ones of the plurality of real properties on offer being generated using the property data and the purchaser data. The property compatibility index may be displayed to a user.

In an embodiment, the processor interface further receives finance data indicative of the loan qualification characteristics. The index generation modules may use the finance data to generate the property compatibility index.

In an embodiment, a user interface is operated to specify a plurality of weighting factors, and comprises the step of weighting a plurality of other indexes with the plurality of weighting factors. The plurality of other indexes so weighted may be used to generate the property compatibility index for each of the non-excluded ones of the plurality of real properties on offer. The user interface may constrain the plurality of weighting factors such that a sum of the plurality of weighting factors remains constant. The user interface may generate: a graphic indicative of the sum of the plurality of weighting factors; and a marker operable for a user to divide the graphic into a plurality of portions, each portion being indicative of a magnitude of each of the plurality of weighting factors. Examples of suitable graphics include but are not limited to a region, a line, a box, a circle, and a representation of an object such as a house. Generally the graphic may be any suitable graphic.

In an embodiment, the step of generating the property compatibility index for each of the non-excluded ones of the plurality of real properties comprises the steps of:
generating at least one local area index indicative of at least one characteristic of a local area in which each of the non-excluded ones of the plurality of properties is located;
generating at least one property site index indicative of at least one characteristic of a property site included in the real property on offer; and
weighting at least one of the local area index and the property site index by one or more of the plurality of weighting factors.

In an embodiment, the user interface may be operated to input at least one response to a questionnaire, the at least one response being indicative of the at least one characteristic of the purchaser, and the step of generating the property compatibility index comprises the steps of:
determining at least one score indicative of the at least one response; and
including the at least one score in the generation of the property compatibility index. The user interface may present the questionnaire to the user.

In an embodiment, the user interface is a graphical user interface.

An embodiment further comprising a step of:
generating a list of properties comprising the non-excluded ones of the plurality of real properties on offer ranked in order of compatibility index.

The exclusion criteria may include, for example, that a property outside of a geographic area is excluded. For example, a property outside of at least one of Sydney or NSW may be excluded. Generally any exclusion criteria may be used. The exclusion criteria may be expressed as an inclusion criteria, for example only include a property if it is in at least one of Sydney and NSW.

In an embodiment, the at least one characteristic of the purchaser is selected from a group comprising:
a date of birth of the purchaser;
a date of birth of each dependent of the purchaser;
a risk profile of the purchaser;
gross annual personal taxable income received by the purchaser;
annual salary sacrifice made by the purchaser;
annual government benefits received by the purchaser;
annual non-taxable income received by the purchaser;
annual personal expenses of the purchaser;
annual rental expenses of the purchaser;
total limit on each credit card of the purchaser;
non-property annual investment expenses of the purchaser;
for each additional property in an existing portfolio of the purchaser, a settlement date of the additional property;
for each additional property in an existing portfolio of the purchaser, an original purchase price of the additional property;
for each additional property in an existing portfolio of the purchaser, an address of the additional property;
for each additional property in an existing portfolio of the purchaser, a current market value of the additional property;
for each additional property in an existing portfolio of the purchaser, whether the additional property is for a personal or investment purpose;
for each additional property in an existing portfolio of the purchaser, a percentage ownership allocation of the additional property;
for each additional property in an existing portfolio of the purchaser, an annual rental income of the additional property;
for each additional property in an existing portfolio of the purchaser, a maximum loan-to-valuation ratio permitted by the purchaser for the additional property;
for each additional property in an existing portfolio of the purchaser, a current loan balance of the additional property;
for each additional property in an existing portfolio of the purchaser, an annual loan interest payable for the additional property;
for each additional property in an existing portfolio of the purchaser, an amount of annual total expenses payable, for the additional property, excluding mortgage interest expenses;
for each additional property in an existing portfolio of the purchaser, any deductions for borrowing, plant, and capital works for the additional property;
for each additional mortgage in an existing portfolio of the purchaser, a financier for the additional mortgage;
for each additional mortgage in an existing portfolio of the purchaser, a type of the additional mortgage;
for each mortgage in an existing portfolio of the purchaser, whether the additional mortgage is for a personal or investment purpose;
for each additional mortgage in an existing portfolio of the purchaser, a redraw limit of the additional mortgage;
for each additional mortgage in an existing portfolio of the purchaser, a current balance of the additional mortgage;
for each additional mortgage in an existing portfolio of the purchaser, a current interest rate of the additional mortgage;
for each additional mortgage in an existing portfolio of the purchaser, whether an interest rate for the additional mortgage is fixed or variable;
for each mortgage in an existing portfolio of the purchaser, a date on which a fixed-interest rate period for the additional mortgage ends;
for each fixed-interest rate mortgage in an existing portfolio of the purchaser, an amount of a penalty for discharging the additional mortgage before a fixed-interest rate period ends;
for each mortgage in an existing portfolio of the purchaser, an amount of a penalty payable if the additional mortgage is discharged early;
for each additional mortgage in an existing portfolio of the purchaser, a current amount payable for the additional mortgage;
for each additional mortgage in an existing portfolio of the purchaser, a frequency of payments for the additional mortgage;
for each additional mortgage in an existing portfolio of the purchaser, any annual account fees payable for the additional mortgage;
for each additional mortgage in an existing portfolio of the purchaser, a date on which a term of the additional mortgage ends;
for each additional loan of the purchaser, not including any loan for additional property in a portfolio of the purchaser, a financier of the additional loan;
for each additional loan of the purchaser, not including any loan for additional property in a portfolio of the purchaser, a type of the additional loan;
for each additional loan of the purchaser, not including any loan for additional property in a portfolio of the purchaser, whether the additional loan is for a personal or investment purpose;
for each additional loan of the purchaser, not including any loan for additional property in a portfolio of the purchaser, a redraw limit of the additional loan;
for each additional loan of the purchaser, not including any loan for additional property in a portfolio of the purchaser, a current balance of the additional loan;
for each additional loan of the purchaser, not including any loan for additional property in a portfolio of the purchaser, a current interest rate of the additional loan;
for each additional loan of the purchaser, not including any loan for additional property in a portfolio of the purchaser, whether an interest rate of the additional loan is fixed or variable;
for each additional loan of the purchaser, not including any loan for additional property in a portfolio of the purchaser, a date on which a fixed-interest rate period ends;
for each additional fixed-interest rate loan of the purchaser, not including any loan for additional property in a portfolio of the purchaser, an amount of a penalty for discharging the additional loan before a fixed-interest rate period ends;
for each additional loan of the purchaser, not including any loan for additional property in a portfolio of the purchaser, any amount of any penalty payable if the additional loan is discharged early;
for each additional loan of the purchaser, not including any loan for additional property in a portfolio of the purchaser, a current payment amount of the additional loan;
for each additional loan of the purchaser, not including any loan for additional property in a portfolio of the purchaser, a frequency of payments for the additional loan; and
for each additional loan of the purchaser, not including any loan for additional property in a portfolio of the purchaser, an amount of any annual account fees on the additional loan.

In an embodiment, the property data indicative of the at least one characteristic of each of the non-excluded ones of the real properties on offer is selected from a group comprising:
an address of the real property;
a suburb in which the real property is located;
a state in which the real property is located;
a postcode for the real property;
a local government area for the real property;
a set of map coordinates for the real property;
a total number of bedrooms included in the real property;
a total number of bathrooms included in the real property;
a total number of car spaces included in the real property;
a size of a land component of the real property;
a housing type classification for the real property;
a market value of the real property;
a value of costs associated with purchasing the real property;
a value of annual costs associated with owning the real property;
a rental income of the real property;
a future deduction information for the real property for 40 years;
an original asking price for the real property;
a current asking price for the real property;
a date on which the real property was listed for sale.
a percentage of a local population who live in a local area in which the real property is located and are aged between 0-17 years, 18-24 years, 25-54 years, 55-65 years, 66+ years;
a percentage of a local population who live in a local area in which the real property is located and rent accommodation;
a total number of people who have resided over the last five years in a local area in which the real property is located;
a percentage of a local population who live in a local area in which the real property is located and who are unemployed;
a median household income of a local population who live in a local area in which the real property is located;
a median household debt of a local population who live in a local area in which the real property is located;
a median house sale price for a local area in which the real property is located;
a median unit sale price for a local area in which the real property is located;
a median land price for a local area in which the real property is located;
a median commercial sale price for a local area in which the real property is located;
a median property price for a local area in which the real property is located;
a median rent for houses in a local area in which the real property is located;
a median rent for units in a local area in which the real property is located;
a median rent for commercial properties in a local area in which the real property is located;
a median rent for all properties in a local area in which the real property is located;
a total number of residential and commercial land lots available in a local area in which the real property is located;
a total number of development approvals for houses in a local area in which the real property is located;
a total number of development approvals for units in a local area in which the real property is located;
a total number of development approvals for commercial properties in a local area in which the real property is located;
an average time for developments to be approved in a local area in which the real property is located;
a total number of members per household in a local area in which the real property is located;
a total number of established house dwellings in a local area in which the real property is located;
a total number of established unit dwellings in a local area in which the real property is located;
a total number of established commercial premises in a local area in which the real property is located;
a percentage of properties which are rented in a local area in which the real property is located;
a percentage of properties having no mortgage in a local area in which the real property is located;
a percentage of properties which are mortgaged in a local area in which the real property is located;
a percentage of houses which are vacant in a local area in which the real property is located;
a percentage of units which are vacant in a local area in which the real property is located;
a percentage of commercial properties which are vacant in a local area in which the real property is located;
a total number of houses on offer for sale in a local area in which the real property is located;
a total number of lots of land on offer for sale in a local area in which the real property is located;
a total number of commercial properties on offer for sale in a local area in which the real property is located;
a total number of units available for rent in a local area in which the real property is located;
a total number of houses available for rent in a local area in which the real property is located;
a total number of commercial properties available for rent in a local area in which the real property is located;
a median property size in a local area in which the real property is located;
a total number of houses sold over the last 12 months in a local area in which the real property is located;
a total number of units sold over the last 12 months in a local area in which the real property is located;
a total number of commercial properties sold over the last 12 months in a local area in which the real property is located;
a percentage yield for all properties in a local area in which the real property is located;
a percentage yield for houses in a local area in which the real property is located;
a percentage yield for units in a local area in which the real property is located;
a percentage yield for commercial properties in a local area in which the real property is located;
a yield per square metre for all properties in a local area in which the real property is located;
a percentage of properties which are houses in a local area in which the real property is located;
a percentage of properties which are units in a local area in which the real property is located;
a mortgage delinquency rating for a local area in which the real property is located;
a total number of property starts in a local area in which the real property is located;
a crime rate for a local area in which the real property is located;
a consumer price index in a local area in which the real property is located;
a gross domestic product in a country in which the real property is located;
a gross regional product in a local area in which the real property is located;
an employment vulnerability index for a local area in which the real property is located;
an average number of years a resident stays in a local area in which the real property is located;
a total number of residential properties on offer for sale in a local area in which the real property is located;
an average number of days that properties are on offer for sale in a local area in which the real property is located;
an average percentage that properties are discounted when sold in a local area in which the real property is located;
a total number of properties on offer within price deviation of $50,000 in a local area in which the real property is located;
a value of any funded planned infrastructure developments in a local area in which the real property is located;
a growth of employment in a local area in which the real property is located;
any indicators of business growth in a local area in which the real property is located;
types of transport road, rail and port links available in a local area in which the real property is located;
any commercial infrastructure funding in a local area in which the real property is located;
a rental cost per square metre of commercial space in a local area in which the real property is located;
a ratio of population to a total number of dwellings in a local area in which the real property is located;
a cost per square metre of housing construction in a local area in which the real property is located;
a level at which financiers will fund properties in a local area in which the real property is located;
a cost of living in a local area in which the real property is located;
an energy tariff rate in a local area in which the real property is located;
a total population in a local area in which the real property is located; and
a measure of diversification of industry in a local area in which the real property is located.

In an embodiment, the finance data indicative of the loan qualification characteristics comprises a financier's first qualification criteria for loan-to-valuation ratio in relation to finance for each of the non-excluded ones of the plurality of real properties on offer. The finance data indicative of the loan qualification characteristics may further comprise a financier's second qualification criteria for an ability of the purchaser to service a loan to purchase each of the non-excluded ones of the plurality of real properties on offer.

In an embodiment, the processor interface comprises a processor-network interface.

Disclosed herein is a system for determining the compatibility of a purchaser with a plurality of real properties on offer. The system is arranged to exclude those of the plurality of real properties on offer that match at least one exclusion criterion. The system is arranged to use a plurality of characteristics to generate, for each of the non-excluded ones of the plurality of real properties on offer, a property compatibility index indicative of a degree of compatibility between the corresponding real property and the purchaser. The plurality of characteristics comprises at least one characteristic of the purchaser and at least one characteristic of each of the non-excluded ones of the plurality of real properties on offer.

In an embodiment, the plurality of characteristics further comprises loan qualification characteristics indicative of a probability that the purchaser will qualify for finance for each of the non-excluded ones of the plurality of real properties on offer.

An embodiment comprises a processor interface of a processor arranged to receive: purchaser data indicative of the at least one characteristic of the purchaser; and property data indicative of the at least one characteristic of each of the plurality of real properties. This embodiment may include a real property exclusion module arranged to exclude those of the real properties on offer that match at least one exclusion criterion. This embodiment may include an index generation module of the processor arranged to generate the property compatibility index for each of the non-excluded ones of the plurality of properties on offer, the property compatibility index for each of the non-excluded ones of the plurality of real properties on offer being generated using the property data and the purchaser data.

In an embodiment, the processor interface is further arranged to receive finance data indicative of the loan qualification characteristics. The index generation module may be arranged to generate the property compatibility index using the finance data for each of the non-excluded ones of the plurality of real properties on offer.

An embodiment comprises a user interface operable for a user to specify a plurality of weighting factors. The index generation module may be arranged to weight a plurality of other indexes with the plurality of weighting factors and using the plurality of other indexes so weighted to generate the property compatibility index.

In an embodiment, the user interface is arranged to constrain the plurality of weighting factors such that a sum of the plurality of weighting factors remains constant.

In an embodiment, the user interface is arranged to generate: a graphic indicative of the sum of the plurality of weighting factors; and a marker operable for a user to divide the graphic into a plurality of portions, each portion being indicative of a magnitude of each of the plurality of weighting factors.

In an embodiment, the user interface is operable for a user to input at least one response to a questionnaire, and the index generation module is arranged to:

determine at least one score indicative of the at least one response; and
include the at least one score in the generation of the property compatibility index for each of the non-excluded ones of the plurality of real properties on offer.

In an embodiment, the user interface is a graphical user interface.

In an embodiment, the index generation module is arranged to:
generate at least one local area index indicative of at least one characteristic of a local area in which each of the non-excluded ones of the plurality of properties is located;
generate at least one property site index indicative of at least one characteristic of a property site included in the real property on offer; and
weight at least one of the local area index and the property site index by one or more of the plurality of weighting factors.

In an embodiment, the system further comprises:
a list generation module arranged to generate a list of properties comprising the non-excluded ones of the plurality of real properties ranked in order of compatibility index.

In an embodiment, the at least one characteristic of the purchaser is selected from a group comprising:
a date of birth of the purchaser;
a date of birth of each dependent of the purchaser;
a risk profile of the purchaser;
gross annual personal taxable income received by the purchaser;
annual salary sacrifice made by the purchaser;
annual government benefits received by the purchaser;
annual non-taxable income received by the purchaser;
annual personal expenses of the purchaser;
annual rental expenses of the purchaser;
total limit on each credit card of the purchaser;
non-property annual investment expenses of the purchaser;
for each additional property in an existing portfolio of the purchaser, a settlement date of the additional property;
for each additional property in an existing portfolio of the purchaser, an original purchase price of the additional property;
for each additional property in an existing portfolio of the purchaser, an address of the additional property;
for each additional property in an existing portfolio of the purchaser, a current market value of the additional property;
for each additional property in an existing portfolio of the purchaser, whether the additional property is for a personal or investment purpose;
for each additional property in an existing portfolio of the purchaser, a percentage ownership allocation of the additional property;
for each additional property in an existing portfolio of the purchaser, an annual rental income of the additional property;
for each additional property in an existing portfolio of the purchaser, a maximum loan-to-valuation ratio permitted by the purchaser for the additional property;
for each additional property in an existing portfolio of the purchaser, a current loan balance of the additional property;
for each additional property in an existing portfolio of the purchaser, an annual loan interest payable for the additional property;
for each additional property in an existing portfolio of the purchaser, an amount of annual total expenses payable, for the additional property, excluding mortgage interest expenses;
for each additional property in an existing portfolio of the purchaser, any deductions for borrowing, plant, and capital works for the additional property;
for each additional mortgage in an existing portfolio of the purchaser, a financier for the additional mortgage;
for each additional mortgage in an existing portfolio of the purchaser, a type of the additional mortgage;
for each mortgage in an existing portfolio of the purchaser, whether the additional mortgage is for a personal or investment purpose;
for each additional mortgage in an existing portfolio of the purchaser, a redraw limit of the additional mortgage;
for each additional mortgage in an existing portfolio of the purchaser, a current balance of the additional mortgage;
for each additional mortgage in an existing portfolio of the purchaser, a current interest rate of the additional mortgage;
for each additional mortgage in an existing portfolio of the purchaser, whether an interest rate for the additional mortgage is fixed or variable;
for each mortgage in an existing portfolio of the purchaser, a date on which a fixed-interest rate period for the additional mortgage ends;
for each fixed-interest rate mortgage in an existing portfolio of the purchaser, an amount of a penalty for discharging the additional mortgage before a fixed-interest rate period ends;
for each mortgage in an existing portfolio of the purchaser, an amount of a penalty payable if the additional mortgage is discharged early;
for each additional mortgage in an existing portfolio of the purchaser, a current amount payable for the additional mortgage;
for each additional mortgage in an existing portfolio of the purchaser, a frequency of payments for the additional mortgage;
for each additional mortgage in an existing portfolio of the purchaser, any annual account fees payable for the additional mortgage;
for each additional mortgage in an existing portfolio of the purchaser, a date on which a term of the additional mortgage ends;
for each additional loan of the purchaser, not including any loan for additional property in a portfolio of the purchaser, a financier of the additional loan;
for each additional loan of the purchaser, not including any loan for additional property in a portfolio of the purchaser, a type of the additional loan;
for each additional loan of the purchaser, not including any loan for additional property in a portfolio of the purchaser, whether the additional loan is for a personal or investment purpose;
for each additional loan of the purchaser, not including any loan for additional property in a portfolio of the purchaser, a redraw limit of the additional loan;
for each additional loan of the purchaser, not including any loan for additional property in a portfolio of the purchaser, a current balance of the additional loan;
for each additional loan of the purchaser, not including any loan for additional property in a portfolio of the purchaser, a current interest rate of the additional loan;
for each additional loan of the purchaser, not including any loan for additional property in a portfolio of the purchaser, whether an interest rate of the additional loan is fixed or variable;
for each additional loan of the purchaser, not including any loan for additional property in a portfolio of the purchaser, a date on which a fixed-interest rate period ends;
for each additional fixed-interest rate loan of the purchaser, not including any loan for additional property in a portfolio of the purchaser, an amount of a penalty for discharging the additional loan before a fixed-interest rate period ends;
for each additional loan of the purchaser, not including any loan for additional property in a portfolio of the purchaser, any amount of any penalty payable if the additional loan is discharged early;
for each additional loan of the purchaser, not including any loan for additional property in a portfolio of the purchaser, a current payment amount of the additional loan;
for each additional loan of the purchaser, not including any loan for additional property in a portfolio of the purchaser, a frequency of payments for the additional loan; and
for each additional loan of the purchaser, not including any loan for additional property in a portfolio of the purchaser, an amount of any annual account fees on the additional loan.

In an embodiment, the at least one characteristic each of the non-excluded ones of the plurality of real properties on offer is selected from a group comprising:
an address of the real property;
a suburb in which the real property is located;
a state in which the real property is located;
a postcode for the real property;
a local government area for the real property;
a set of map coordinates for the real property;
a total number of bedrooms included in the real property;
a total number of bathrooms included in the real property;
a total number of car spaces included in the real property;
a size of a land component of the real property;
a housing type classification for the real property;
a market value of the real property;
a value of costs associated with purchasing the real property;
a value of annual costs associated with owning the real property;
a rental income of the real property;
a future deduction information for the real property for 40 years;
an original asking price for the real property;
a current asking price for the real property;
a date on which the real property was listed for sale.
a percentage of a local population who live in a local area in which the real property is located and are aged between 0-17 years, 18-24 years, 25-54 years, 55-65 years, 66+ years;
a percentage of a local population who live in a local area in which the real property is located and rent accommodation;
a total number of people who have resided over the last five years in a local area in which the real property is located;
a percentage of a local population who live in a local area in which the real property is located and who are unemployed;
a median household income of a local population who live in a local area in which the real property is located;
a median household debt of a local population who live in a local area in which the real property is located;
a median house sale price for a local area in which the real property is located;
a median unit sale price for a local area in which the real property is located;
a median land price for a local area in which the real property is located;
a median commercial sale price for a local area in which the real property is located;
a median property price for a local area in which the real property is located;
a median rent for houses in a local area in which the real property is located;
a median rent for units in a local area in which the real property is located;
a median rent for commercial properties in a local area in which the real property is located;
a median rent for all properties in a local area in which the real property is located;
a total number of residential and commercial land lots available in a local area in which the real property is located;
a total number of development approvals for houses in a local area in which the real property is located;
a total number of development approvals for units in a local area in which the real property is located;
a total number of development approvals for commercial properties in a local area in which the real property is located;
an average time for developments to be approved in a local area in which the real property is located;
a total number of members per household in a local area in which the real property is located;
a total number of established house dwellings in a local area in which the real property is located;
a total number of established unit dwellings in a local area in which the real property is located;
a total number of established commercial premises in a local area in which the real property is located;
a percentage of properties which are rented in a local area in which the real property is located;
a percentage of properties having no mortgage in a local area in which the real property is located;
a percentage of properties which are mortgaged in a local area in which the real property is located;
a percentage of houses which are vacant in a local area in which the real property is located;
a percentage of units which are vacant in a local area in which the real property is located;
a percentage of commercial properties which are vacant in a local area in which the real property is located;
a total number of houses on offer for sale in a local area in which the real property is located;
a total number of lots of land on offer for sale in a local area in which the real property is located;
a total number of commercial properties on offer for sale in a local area in which the real property is located;
a total number of units available for rent in a local area in which the real property is located;
a total number of houses available for rent in a local area in which the real property is located;
a total number of commercial properties available for rent in a local area in which the real property is located;
a median property size in a local area in which the real property is located;
a total number of houses sold over the last 12 months in a local area in which the real property is located;
a total number of units sold over the last 12 months in a local area in which the real property is located;
a total number of commercial properties sold over the last 12 months in a local area in which the real property is located;
a percentage yield for all properties in a local area in which the real property is located;
a percentage yield for houses in a local area in which the real property is located;
a percentage yield for units in a local area in which the real property is located;
a percentage yield for commercial properties in a local area in which the real property is located;
a yield per square metre for all properties in a local area in which the real property is located;
a percentage of properties which are houses in a local area in which the real property is located;
a percentage of properties which are units in a local area in which the real property is located;
a mortgage delinquency rating for a local area in which the real property is located;
a total number of property starts in a local area in which the real property is located;
a crime rate for a local area in which the real property is located;
a consumer price index in a local area in which the real property is located;
a gross domestic product in a country in which the real property is located;
a gross regional product in a local area in which the real property is located;
an employment vulnerability index for a local area in which the real property is located;
an average number of years a resident stays in a local area in which the real property is located;
a total number of residential properties on offer for sale in a local area in which the real property is located;
an average number of days that properties are on offer for sale in a local area in which the real property is located;
an average percentage that properties are discounted when sold in a local area in which the real property is located;
a total number of properties on offer within price deviation of $50,000 in a local area in which the real property is located;
a value of any funded planned infrastructure developments in a local area in which the real property is located;
a growth of employment in a local area in which the real property is located;
any indicators of business growth in a local area in which the real property is located;
types of transport road, rail and port links available in a local area in which the real property is located;
any commercial infrastructure funding in a local area in which the real property is located;
a rental cost per square metre of commercial space in a local area in which the real property is located;
a ratio of population to a total number of dwellings in a local area in which the real property is located;
a cost per square metre of housing construction in a local area in which the real property is located;
a level at which financiers will fund properties in a local area in which the real property is located;
a cost of living in a local area in which the real property is located;
an energy tariff rate in a local area in which the real property is located;
a total population in a local area in which the real property is located; and
a measure of diversification of industry in a local area in which the real property is located.

In an embodiment, the finance data indicative of the loan qualification characteristics comprises:

a financier's first qualification criteria for loan-to-valuation ratio in relation to finance for each of the non-excluded ones of the plurality of real properties on offer;
a financier's second qualification criteria for an ability of the purchaser to service a loan to purchase each of the non-excluded ones of the plurality of real properties on offer.

In an embodiment, the processor interface comprises a processor-network interface.

Disclosed herein is processor-readable tangible media including program instructions which when executed by a processor causes the processor to perform a method disclosed above.

Disclosed herein is a computer program for instructing a processor, which when executed by the processor causes the processor to perform a method described above.

Any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIG. 1 is a block diagram of an embodiment of a system for ranking a plurality of real properties on offer.

FIG. 2 is an example of a user interface that is used in the system shown in FIG. 1.

FIG. 3 is a flow diagram of an embodiment of a method for ranking a plurality of real properties on offer.

FIG. 4 shows a schematic diagram of an example architecture of a processor of the system of FIG. 1.

### DESCRIPTION OF EMBODIMENTS

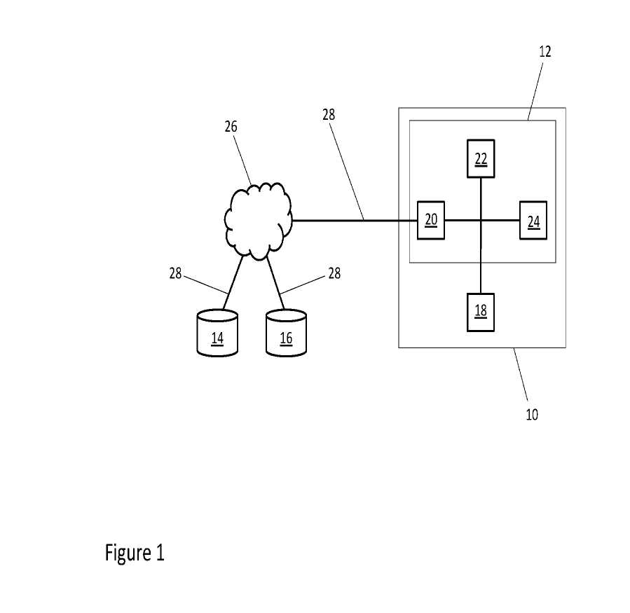

FIG. 1 is a block diagram of an embodiment of a system for ranking a plurality of real properties on offer, the system being generally indicated by the numeral 10. The system 10 includes a processor 12 which is networked to communicate with a property database 14 containing property data and a purchaser database 16 containing purchaser data. The system also includes a user interface 18 arranged to generate additional purchaser data. The system 10 is in communication with the property database 14 and the purchaser database 16 via a computer network 26. The purchaser database and the property database, in this but not necessarily in all embodiments, comprise at least one computer server having database software, examples of which include but are not limited to SQL and FILEMAKER. The property database is, in this but not necessarily in all embodiments, controlled by a third party and the property data may be compiled by the third party.

Data is received from the property database 14 and purchaser database 16 via a processor interface 20, which in this embodiment comprises a processor-network interface comprising a network interface card. The interface 20 is in communication with other modules in the processor, including an index generation module 22 and a list generation module 24.

This embodiment of the system 10 processes the purchaser data and the property data and generates a property compatibility index for each property. The property compatibility index may be used by a purchaser to rank multiple properties in terms of compatibility with their own preferences or circumstances. The generated property compatibility indexes may be displayed by the system 10 on an electronic display, or stored in non-volatile memory for future use by the purchaser, for example. The property compatibility index may be used by a purchaser to generate a short list of properties that are worthy of closer inspection, and thereby avoid wasting time reviewing properties that are less compatible with their preferences.

The property data used by the processor 12 is received from the property database 14. Although the property database 14 is shown as a single database in the embodiment in FIG. 1, the property database may comprise a plurality of databases, and each database may be provided by a different party. For example, the property database 14 may comprise information extracted manually or automatically from documents, including reports about the demographics of an area in which a property is located. There are many potential sources of property data. Examples of sources of property data include, but are not limited to:
data from censuses;
data from real estate agent property;
data from property industry specialists;
data from by local councils;
data about employment; and
data from property developers.

Many types of information may be included in the property data. For example, the property data may comprise information indicative of characteristics of a property site, including a dwelling and/or land in a property on offer. Additionally or alternatively, the property data may comprise information indicative of characteristics of an area or demographics of an area in which a property is located. Examples of information about a property that may be included in the property data include, but are not limited to, the following:
an address of the real property;
a suburb in which the real property is located;
a state in which the real property is located;
a postcode for the real property;
a local government area for the real property;
a set of map coordinates for the real property;
a total number of bedrooms included in the real property;
a total number of bathrooms included in the real property;
a total number of car spaces included in the real property;
a size of a land component of the real property;
a housing type classification for the real property;
a market value of the real property;
a value of costs associated with purchasing the real property;
a value of annual costs associated with owning the real property;
a rental income of the real property;
a future deduction information for the real property for 40 years;
an original asking price for the real property;
a current asking price for the real property;
a date on which the real property was listed for sale.
a percentage of a local population who live in a local area in which the real property is located and are aged between 0-17 years, 18-24 years, 25-54 years, 55-65 years, 66+ years;
a percentage of a local population who live in a local area in which the real property is located and rent accommodation;
a total number of people who have resided over the last five years in a local area in which the real property is located;
a percentage of a local population who live in a local area in which the real property is located and who are unemployed;
a median household income of a local population who live in a local area in which the real property is located;
a median household debt of a local population who live in a local area in which the real property is located;
a median house sale price for a local area in which the real property is located;
a median unit sale price for a local area in which the real property is located;
a median land price for a local area in which the real property is located;
a median commercial sale price for a local area in which the real property is located;
a median property price for a local area in which the real property is located;
a median rent for houses in a local area in which the real property is located;
a median rent for units in a local area in which the real property is located;
a median rent for commercial properties in a local area in which the real property is
a median rent for all properties in a local area in which the real property is located;
a total number of residential and commercial land lots available in a local area in which the real property is located;
a total number of development approvals for houses in a local area in which the real property is located;
a total number of development approvals for units in a local area in which the real property is located;
a total number of development approvals for commercial properties in a local area in which the real property is located;
an average time for developments to be approved in a local area in which the real property is located;
a total number of members per household in a local area in which the real property is located;
a total number of established house dwellings in a local area in which the real property is located;
a total number of established unit dwellings in a local area in which the real property is located;
a total number of established commercial premises in a local area in which the real property is located;
a percentage of properties which are rented in a local area in which the real property is located;
a percentage of properties having no mortgage in a local area in which the real property is located;
a percentage of properties which are mortgaged in a local area in which the real property is located;
a percentage of houses which are vacant in a local area in which the real property is located;
a percentage of units which are vacant in a local area in which the real property is located;
a percentage of commercial properties which are vacant in a local area in which the real property is located;
a total number of houses on offer for sale in a local area in which the real property is located;
a total number of lots of land on offer for sale in a local area in which the real
a total number of commercial properties on offer for sale in a local area in which the real property is located;
a total number of units available for rent in a local area in which the real property is located;
a total number of houses available for rent in a local area in which the real property is located;
a total number of commercial properties available for rent in a local area in which the real property is located;
a median property size in a local area in which the real property is located;
a total number of houses sold over the last 12 months in a local area in which the real property is located;
a total number of units sold over the last 12 months in a local area in which the real property is located;
a total number of commercial properties sold over the last 12 months in a local area in which the real property is located;
a percentage yield for all properties in a local area in which the real property is located;
a percentage yield for houses in a local area in which the real property is located;
a percentage yield for units in a local area in which the real property is located;
a percentage yield for commercial properties in a local area in which the real property is located;
a yield per square metre for all properties in a local area in which the real property is located;
a percentage of properties which are houses in a local area in which the real property is located;
a percentage of properties which are units in a local area in which the real property is located;
a mortgage delinquency rating for a local area in which the real property is located;
a total number of property starts in a local area in which the real property is located;
a crime rate for a local area in which the real property is located;
a consumer price index in a local area in which the real property is located;
a gross domestic product in a country in which the real property is located;
a gross regional product in a local area in which the real property is located;
an employment vulnerability index for a local area in which the real property is
an average number of years a resident stays in a local area in which the real property is located;
a total number of residential properties on offer for sale in a local area in which the real property is located;
an average number of days that properties are on offer for sale in a local area in which the real property is located;
an average percentage that properties are discounted when sold in a local area in which the real property is located;
a total number of properties on offer within price deviation of $50,000 in a local area in which the real property is located;
a value of any funded planned infrastructure developments in a local area in which the real property is located;
a growth of employment in a local area in which the real property is located;
any indicators of business growth in a local area in which the real property is located;
types of road transport, rail transport and sea transport links available in a local area in which the real property is located;
any commercial infrastructure funding in a local area in which the real property is located;
a rental cost per square metre of commercial space in a local area in which the real property is located;
a ratio of population to a total number of dwellings in a local area in which the real property is located;
a cost per square metre of housing construction in a local area in which the real property is located;
a level at which financiers will fund properties in a local area in which the real property is located;
a cost of living in a local area in which the real property is located;
an energy tariff rate in a local area in which the real property is located;
a total population in a local area in which the real property is located; and
a measure of diversification of industry in a local area in which the real property is located.

The purchaser data used by the processor 12 is received from the purchaser database 16 and/or from information generated by a user operating the user interface 18. Although the purchaser database 16 is shown as a single database in the embodiment in FIG. 1, the purchaser database may comprise a plurality of databases, and each database may be provided by a different party. For example, the property database 16 may comprise information extracted manually or automatically from documents or digital pages, including reports about the purchaser. There are many potential sources of purchaser data. Examples of sources of purchaser data include, but are not limited to:
information compiled by an advisor to the purchaser;
accounting records relating to the purchaser;
tax return records relating to the purchaser;
information submitted by the purchaser in response to a questionnaire;
information generated by the user interface 18 (described below).

Many types of information may be included in the purchaser data. Examples of information that may be included in the purchaser data include, but are not limited to, the following:
a date of birth of the purchaser;
a date of birth of each dependent of the purchaser;
a risk profile of the purchaser;
gross annual personal taxable income received by the purchaser;
annual salary sacrifice made by the purchaser;
annual government benefits received by the purchaser;
annual non-taxable received by the purchaser;
annual personal expenses of the purchaser;
annual rental expenses of the purchaser;
total limit on each credit card of the purchaser;
non-property annual investment expenses of the purchaser;
for each additional property in an existing portfolio of the purchaser, a settlement date of the additional property;
for each additional property in an existing portfolio of the purchaser, an original purchase price of the additional property;
for each additional property in an existing portfolio of the purchaser, an address of the additional property;
for each additional property in an existing portfolio of the purchaser, a current market value of the additional property;
for each additional property in an existing portfolio of the purchaser, whether the additional property is for a personal or investment purpose;
for each additional property in an existing portfolio of the purchaser, a percentage ownership allocation of the additional property;
for each additional property in an existing portfolio of the purchaser, an annual rental income of the additional property;
for each additional property in an existing portfolio of the purchaser, a maximum loan-to-valuation ratio permitted by the purchaser for the additional property;
for each additional property in an existing portfolio of the purchaser, a current loan balance of the additional property;
for each additional property in an existing portfolio of the purchaser, an annual loan interest payable for the additional property;
for each additional property in an existing portfolio of the purchaser, an amount of annual total expenses payable, for the additional property, excluding mortgage interest expenses;
for each additional property in an existing portfolio of the purchaser, any deductions for borrowing, plant, and capital works for the additional property;
for each additional mortgage in an existing portfolio of the purchaser, a financier for the additional mortgage;
for each additional mortgage in an existing portfolio of the purchaser, a type of the additional mortgage;
for each mortgage in an existing portfolio of the purchaser, whether the additional mortgage is for a personal or investment purpose;
for each additional mortgage in an existing portfolio of the purchaser, a redraw limit of the additional mortgage;
for each additional mortgage in an existing portfolio of the purchaser, a current balance of the additional mortgage;
for each additional mortgage in an existing portfolio of the purchaser, a current interest rate of the additional mortgage;
for each additional mortgage in an existing portfolio of the purchaser, whether an interest rate for the additional mortgage is fixed or variable;
for each mortgage in an existing portfolio of the purchaser, a date on which a fixed-interest rate period for the additional mortgage ends;
for each fixed-interest rate mortgage in an existing portfolio of the purchaser, an amount of a penalty for discharging the additional mortgage before a fixed-interest rate period ends;
for each mortgage in an existing portfolio of the purchaser, an amount of a penalty payable if the additional mortgage is discharged early;
for each additional mortgage in an existing portfolio of the purchaser, a current amount payable for the additional mortgage;
for each additional mortgage in an existing portfolio of the purchaser, a frequency of payments for the additional mortgage;
for each additional mortgage in an existing portfolio of the purchaser, any annual account fees payable for the additional mortgage;
for each additional mortgage in an existing portfolio of the purchaser, a date on which a term of the additional mortgage ends;
for each additional loan of the purchaser, not including any loan for additional property in a portfolio of the purchaser, a financier of the additional loan;
for each additional loan of the purchaser, not including any loan for additional property in a portfolio of the purchaser, a type of the additional loan;
for each additional loan of the purchaser, not including any loan for additional property in a portfolio of the purchaser, whether the additional loan is for a personal or investment purpose;
for each additional loan of the purchaser, not including any loan for additional property in a portfolio of the purchaser, a redraw limit of the additional loan;
for each additional loan of the purchaser, not including any loan for additional property in a portfolio of the purchaser, a current balance of the additional loan;
for each additional loan of the purchaser, not including any loan for additional property in a portfolio of the purchaser, a current interest rate of the additional loan;
for each additional loan of the purchaser, not including any loan for additional property in a portfolio of the purchaser, whether an interest rate of the additional loan is fixed or variable;
for each additional loan of the purchaser, not including any loan for additional property in a portfolio of the purchaser, a date on which a fixed-interest rate period ends;
for each additional fixed-interest rate loan of the purchaser, not including any loan for additional property in a portfolio of the purchaser, an amount of a penalty for discharging the additional loan before a fixed-interest rate period ends;
for each additional loan of the purchaser, not including any loan for additional property in a portfolio of the purchaser, any amount of any penalty payable if the
for each additional loan of the purchaser, not including any loan for additional property in a portfolio of the purchaser, a current payment amount of the additional loan;
for each additional loan of the purchaser, not including any loan for additional property in a portfolio of the purchaser, a frequency of payments for the additional loan; and
for each additional loan of the purchaser, not including any loan for additional property in a portfolio of the purchaser, an amount of any annual account fees on the additional loan.

The index generation module 22 may include a process of quantifying the purchaser data, for example by assigning a score or code to each type of data. The score or code may assist in automating the generation of the property compatibility index by the index generation module 22.

In this example, but not necessarily all examples, the processor 12 receives data from the property database 14 and purchaser database 16 over the computer network 26 via connections 28 using Transmission Control Protocol/Internet Protocol (TCP/IP) or generally any suitable protocols. The computer network maybe a point-to-point connection, local area network, wide area network, or the internet for example.

In this example, but not necessarily all examples, the network interface card in the interface 20 is an Ethernet card. Another example of a type of network interface card that may be used is a Token Ring card. In general, the network interface card may be in the form of any interface that enables the processor 12 to communicate over a network with other nodes using an agreed protocol. The interface 26 may also include a higher level messaging layer implemented in software, such as Java, to generate/receive communications with other parties and to generate/receive database queries.

The user interface 18 may be implemented in many ways. For example, the user interface 18 of the present invention comprises a computer monitor, keyboard, mouse and suitable software to prompt the user to input or verify information that may form part of the purchaser data. In one example of the software, the user is asked to input response to a questionnaire. The questionnaire contains questions which may assist in eliciting preferences of the purchaser. For example, as shown in Appendix 1, the questionnaire may elicit information indicative of a risk profile of the purchaser. The user interface software may quantify the purchaser's responses to the questionnaire by assigning scores to each response, and the scores may be used by the index generation module 22 when generating the property compatibility index.

In another example, the user is offered a plurality of defined-format fields which enable the user to input specifications regarding the type of property preferred by the purchaser. The user's inputs may be included in the purchaser data. Examples of property specifications that the user may input include, but are not limited to:
property location—country, state, region, suburb;
proximity to particular local amenities—public transport, shops, schools etc.;
area population—maximum and minimum;
area vacancy rate—maximum and minimum;
property price—maximum and minimum;
property type—for example, unit, townhouse or house;
property land size—maximum and minimum;
bedroom number—maximum and minimum;
property car spaces—maximum and minimum;
days on market—maximum and minimum;
property conveyancing process;
property title structure;
expected pre-tax cash flow for property—maximum and minimum;
expected after-tax cash flow for property—maximum and minimum;
expected pre-tax yield for property—maximum and minimum;
expected loan-value ratio of purchaser's portfolio—maximum and minimum;
expected after-tax cash flow of purchaser's portfolio—maximum and minimum; and
financiers available for the property.

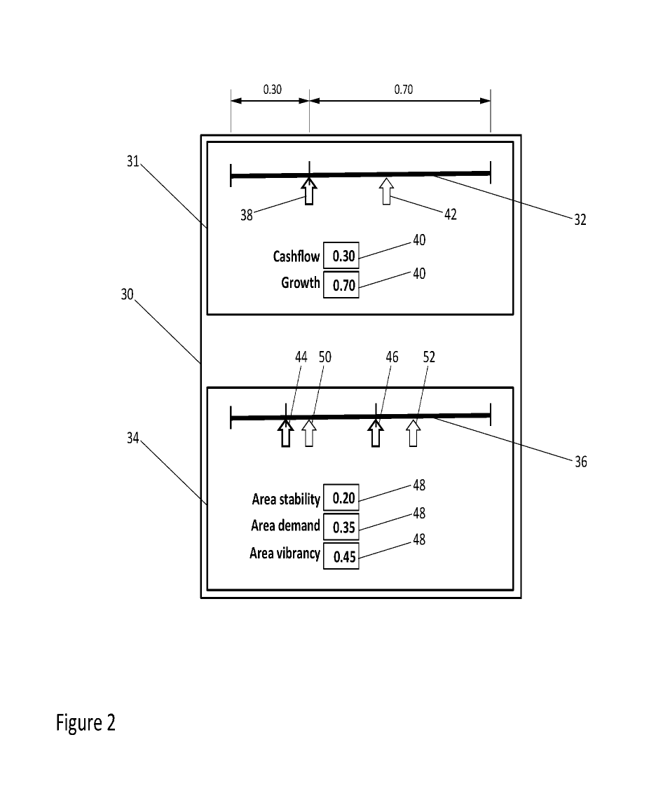

In another example of a user interface 18 defined in this but not necessarily in all embodiments at least in part by interface software, a graphical user interface is generated, being presented on an electronic display, and the user is given the option of adjusting at least one weighting factor indicative of preferences of the purchaser using the graphical user interface when so generated. FIG. 2 shows an example of such a graphical user interface 30, comprising a first panel 31 that includes a graphic in the form of a first slider 32, and a second panel 34 that includes graphic in the form of a second slider 36.

The purpose of the first slider 32 and second slider 36 is to generate weighting factors to be included in the purchaser data. While sliders may be used to generally weight any components of the purchaser data (or real properties data), in this example the first slider 32 generates two weighting factors: a cash flow weighting factor (CW); and a growth weighting factor (GW). The total of these two weighting factors in the example is 1.0. These weighting factors are intended to indicate the purchaser's preferred balance between after tax cash flow yield of a property (and therefore greater cash flow for an investment property) and capital growth of a property. For example, a purchaser who places greater value on cash flow than capital growth may select a cash flow weighting factor which is higher than the growth weighting factor. The user is given the option to adjust the split between the cash flow weighting factor and the growth weighting factor by sliding a marker 38 along the first slider 32. The marker 38 divides the slider 32 into two regions, and each region visually represents a proportion of the slider length associated with each weighting factor. In the example shown in FIG. 2, the user has selected a cash flow weighting factor of 0.30 and a growth weighting factor of 0.70. An advantage of such a slider is that it ensures the weighting factors always add up to a fixed value (the fixed value in this example is 1.0) regardless of the weighting preferences of the purchaser.

The first panel 31 also includes two fields 40 which gives the user the option of directly entering values of the cash flow weighting factor and the growth weighting factor, instead of using the first slider 32. The user interface includes rules that still require the total of the two weighting factors to be 1.0 when entered via the fields 40.

The first slider 32 also includes another marker 42 which indicates the default setting of the split between the cash flow and growth weighting factors. If the user does not make any adjustments to the cash flow or growth weighting factors, the values of the weighting factors will remain the default values indicated by the marker 42, and these values will form part of the purchaser data. In the example shown in FIG. 2, the marker 42 indicates a default cash flow weighting factor of 0.6 and a default growth weighting factor of 0.4. The default values of the weighting factors for cash flow and growth are the same for each user. Alternatively, the default values of these weighting factors may be customized to each user. For example, the default values of the weighting factors may be generated by the index generation module 22 using selected purchaser data collected separately, for example data indicative of at least one of the purchaser's risk profile and personal cash flow.

The second slider 36 generates three weighting factors: an area stability weighting factor (ASW); an area demand weighting factor (ADW); and an area vibrancy weighting factor (AVW). The total of these three weighting factors in the example is 1.0. These weighting factors are intended to indicate the purchaser's preferred balance between characteristics of the area in which the property will be located:
the stability of the area (for example, factors may include but are not limited to population size, percentage of fully-owned properties, age demographics, commercial property vacancy rates, economic stability, and employment trends);
the demand for the area (for example, factors may include but are not limited to rental vacancy rates, property prices, crime rates, and population growth); and
the vibrancy of the area (for example, factors may include but are not limited to shops and services in the area, job availability, transport links in the area, household income in the area, and planned commercial developments).

For example, a purchaser who places greater value on the stability of an area than demand or vibrancy of an area may select an area stability weighting factor which is higher than the area demand weighting factor and area vibrancy weighting factor. The user is given the option to adjust the split between these three weighting by separately sliding two different markers 44, 46 along the second slider 36. The two markers 44, 46 divide the slider into three regions, and each region visually represents a proportion of the slider length associated with each weighting factor. The total of the three weighting factors remains constant (the total is 1.0 in this example), regardless of the positions of the markers 44, 46. In the example shown in FIG. 2, the user has selected an area stability weighting factor of 0.2, an area demand weighting factor of 0.35, and an area vibrancy weighting factor of 0.45. The total of these three factors is 1.0. The second panel 34 also includes three fields 48 which give the user the option of directly entering values of the three weighting factors instead of using the second slider 36. The user interface includes rules that still require the total of the three weighting factors to be 1.0 when entered via the fields 48.

The second slider 36 also includes two other markers 50, 52 which indicate the default setting of the split between the weighting factors for area stability, area demand and area vibrancy. If the user does not make any adjustments to split between the weighting factors for area stability, area demand and area vibrancy, the values of the weighting factors will remain the default values indicated by the markers 50, 52 and these values will form part of the purchaser data. In the example shown in FIG. 2, the markers 50, 52 indicate a default area stability weighting factor of 0.3, a default area demand weighting factor of 0.4 and a default area vibrancy weighting factor of 0.3. The default values of the weighting factors for area stability, area demand and area vibrancy may be set the same for each user. Alternatively, the default values of these weighting factors may be customized to each user. For example, the default values of the weighting factors may be generated by the index generation module 22 using selected purchaser data collected separately, for example data indicative of the purchaser's risk profile.

The sliders 32, 36 shown in FIG. 2 visually indicate the magnitudes of each weighting factor, and enable the user to adjust the weighting factors whilst ensuring the total remains constant. Other types of graphics may be used instead of the linear slider shown in FIG. 2 to achieve the same result. Examples of suitable graphics include but are not limited to regions, lines, boxes and circles.

Referring again to the embodiment in FIG. 1, the index generation module 22 processes purchaser data and property data (including weighting factors when used) and generates property compatibility indices for properties on offer. There are many ways in which the index generation module 22 may generate a property compatibility index. The type of information included in the property data and purchaser data will affect the method used to generate the property compatibility index.

The index generation module 22 does not generally generate a property compatibility index for every property. Instead, the index generation module 22 may select properties (or equivalently exclude properties) that have greatest compatibility with the preferences of the purchaser, based on predetermined criteria, and only generate the property compatibility index for those selected properties. This reduces the computing time by avoiding unnecessary computations and may reduce the waiting time for users of the system 10. For example, if the purchaser data indicates that the purchaser's budget is $1 million, the index generation module 22 may select properties on offer for prices below $1 million (which is the same as excluding properties on offer for at least $1 million) and generate the property compatibility index for those selected properties. Similarly, if the purchaser data indicates that the purchaser should only purchase properties of a particular type, the index generation module 22 may select properties on offer of that type and only generate the property compatibility index for those selected properties. In another example, the index generation module 22 may select properties based on property specifications provided by the user, for example property specifications submitted via the defined-format fields disclosed above, and only generate the property compatibility index for properties that meet the specifications. In this embodiment, the index generation module and the property exclusion module are the same, however in other embodiments they may be distinct.

In one example of the index generation module 22, the method of generating the property compatibility index includes generating at least one other index which may in turn be used to generate the property compatibility index. Each other index may be a function of the property data alone, the purchaser data alone, or both the property data and the purchaser data.

The index generation module 22 may generate, for each property on offer, at least one area index indicative of characteristics of a local area in which the property is located. The local area may be almost any size or shape. The boundaries of the area may be selected to coincide with boundaries used in the available property data. For example, the boundaries of an area may be chosen to coincide with government-defined boundaries. Examples of an area that may be suitable include, but are not limited to: one or more streets; one or more localities; one or more shires; one or more councils; one or more cities; one or more suburbs; one or more regions; one or more states; one or more provinces; and one or more countries.

Each area index is in this but not all embodiments independent of preferences of the purchaser. In one example, the index generation module 22 generates three indices indicative of characteristics of the area based on at least a part of the property data:
an area stability index (ASI), which is a measure of the stability of the area;
an area demand index (ADI), which is a measure of the demand for the area; and
an area vibrancy index (AVI), which is a measure of the vibrancy of the area.

### Area Stability Index (ASI)

There are many ways in which an area stability index may be generated. Generally any suitable method may be used, even simple ones. The following is one example. The area stability index is based on a subset of the property data. In this example, the subset of the property data used in the generation of the area stability index includes, but is not limited to the following stability factors:
population size in the area;
commercial property vacancy rates in the area (economic stability);
industry stability in the area (affects unemployment);
proportion of properties in the area which are rented;
proportion of properties in the area which are fully owned (more fully-owned properties may indicate higher stability);
industry risk in the area (based on number of major industries);
average time a resident stays in the area;
ratio of household income to debt in the area;
demographics of the area;
financier loan-valuation ratios for the area; and
delinquency rating for the area (the higher the rating the less stable the area).

In this example, a numerical score is generated for each of the stability factors based on predetermined rules. Generally any suitable rules, even simple ones, may be used. For each factor, there may also be sub-factors, which may also be scored in the same way. The scores for each factor may be an average of the scores for the corresponding sub-factors.

The scores for all the factors of an area are then added to produce an area stability score (ASS) for that area. The same scoring process is used for all other areas. All of the ASS values are then ranked from highest to lowest, with the lowest ranking being 1 and the highest ranking being n. The ASI for an area is its ASS ranking divided by n.

### EXAMPLE

If area A had an ASS=6496, area B had an ASS=5675, area C had an ASS=7672 and area D had an ASS=8966, then:
Area B's ranking of ASS=1
Area A's ranking of ASS=2
Area C's ranking of ASS=3
Area D's ranking of ASS=4
The highest ranking is n=4, therefore:
For area A, ASI=2/4=0.500
For area B, ASI=1/4=0.2500
For area C, ASI=3/4=0.7500
For area D, ASI=4/4=1.0000

### Area Demand Index (ADI)

There are many ways in which an area demand index may be generated. Generally any suitable method may be used, even simple ones. The following is one example. The area demand index is based on a subset of the property data. In this example, the subset of the property data used in the generation of the area demand index includes, but is not limited to the following demand factors:
population growth in the area;
age demographics of the area;
affordability rating of the area;
residential vacancy rate in the area;
proportion of properties in the area which are rented;
pool of available tenants in the area;
under-valuation of the area (consider whether median property prices are lower than adjacent area)
under-yielding or the area (consider whether median property yield lower than adjacent area);
population market stock ratio (consider the amount of property stock on the market in the area relative to size of the population or number of houses);
clearance rates in property sales in the area;
proportion of properties on offer in the area;
price segment (percentage of properties in the area in a lower segment);
discounting of property prices in the area; and
crime rate in the area.

In this example, a numerical score is generated for each of the demand factors based on predetermined rules. Generally any suitable rules, even very simple ones, may be used. For each factor, there may also be sub-factors, which may also be scored in the same way. The scores for each factor may be an average of the scores for the corresponding sub-factors.

The scores for all the factors of an area are then added to produce an area demand score (ADS) for that area. The same scoring process is used for all other areas. All of the ADS values are then ranked from highest to lowest, with the lowest ranking being 1, and the highest ranking being n. The ADI for an area is its ADS ranking divided by n.

### EXAMPLE

If Area A had an ADS=6496, Area B had an ADS=5675, Area C had an ADS=7672 and Area D had an ADS=8966, then:
Area B's ranking of ADS=1;
Area A's ranking of ADS=2;
Area C's ranking of ADS=3;
Area D's ranking of ADS=4
The highest ranking is n=4, therefore:
For area A, ADI=2/4 ADI=0.500
For area B, ADI=1/4=0.2500
For area C, ADI=3/4=0.7500
For area D, ADI=4/4=1.0000

### Area Vibrancy Index (AVI)

There are many ways in which an area vibrancy index may be generated. Generally, any suitable method may be used, even simple ones. The following is one example. The area vibrancy index is based on a subset of the property data. In this example, the subset of the property data used in the generation of the area vibrancy index includes, but is not limited to the following vibrancy factors:
area economic vibrancy (consider commercial vacancy, commercial yields, commercial building approvals, median commercial pricing);
area commercial vibrancy (consider income growth, job availability, population growth)
area amenity ratio (consider shops, services in the area per population size);
area household income (consider whether median household income is increasing faster than inflation);
area unemployment (consider whether unemployment figures are lower than national average);
area job growth trend (consider job availability, job survey numbers);
area commercial development (consider planned commercial developments, retail, offices, shopping centres);
area planned transport links (consider funded transport links to the area in next 10 years);
area government-funded infrastructure (consider value of planned infrastructure development which has been funded);
area commercial infrastructure funding (consider commercial infrastructure funding in the area); and
area commercial rent per square metre.

In this example, a numerical score is generated for each of the vibrancy factors based on predetermined rules. Generally, any suitable rules, even simple one, may be used. For each factor, there may also be sub-factors, which may also be scored in the same way. The scores for each factor may be an average of the scores for the corresponding sub-factors.

The scores for all the factors of an area are then added to produce an area vibrancy score (AVS) for that area. The same scoring process is used for all other areas. All of the AVS values are then ranked from highest to lowest, with the lowest ranking being 1, and the highest ranking being n. The AVI for an area is its AVS ranking divided by n.

### EXAMPLE

If area A had an AVS=6496, area B had an AVS=5675, area C had an AVS=7672 and area D had an AVS=8966, then:
Area B's ranking of AVS=1;
Area A's ranking of AVS=2;
Area C's ranking of AVS=3;
Area D's ranking of AVS=4
The highest ranking is n=4, therefore:
For area A, AVI=2/4=0.500
For area B, AVI=1/4=0.2500
For area C, AVI=3/4=0.7500
For area D, AVI=4/4=1.0000

### Area Growth Index (AGI)

The index generation module 22 may also generate, for each property on offer, a further index based on both the property data and the purchaser data. For example, an area growth index (AGI) may be generated based at least one area index, for example the three area indices disclosed above, and at least one user-generated area weighting factor, for example the three weighting factors generated with the slider 36 in FIG. 2. In one example, the area growth index (AGI) is generated as follows, however an AGI may be generated using any suitable method, even simple ones.

In this example, a numerical score, referred to as the area growth score (AGS), is generated for each area being considered by a purchaser, as follows:

AGS=(ASI×ASW)+(ADI×ADW)+(AVI×AVW), and where:
ASI=area stability index disclosed above;
ASW=area stability weighting factor disclosed above;
ADI=area demand index disclosed above;
ADW=area demand weighting factor disclosed above;
AVI=area vibrancy index disclosed above; and
AVW=area vibrancy weighting factor disclosed above.

The AGS values are then ranked from highest to lowest, with the lowest ranking being 1, and the highest ranking being n. The AGI for an area is its AGS ranking divided by n.

### EXAMPLE

For example, if an area has an area stability index (ASI)=0.5534, an area demand index (ADI)=0.4849, and an area vibrancy index (AVI)=0.6259 and the purchaser's area growth weightings are: area stability weighting (ASW)=0.45, area demand weighting (ADW)=0.20, and area vibrancy weighting (AVW)=0.35, then

AGS=((0.5534×0.45)+(0.4849×0.2)+(0.6259×0.35))=0.2490+0.0969+0.2190=0.5649
For example, if Area A had an AGS=0.5649, Area B had an AGS=0.4567, Area C had an AGS=0.4767 and Area D had an AGS=0.7896, then:
Area B's ranking of AGS=1;
Area C's ranking of AGS=2;
Area A's ranking of AGS=3;
Area D's ranking of AGS=4.
The highest ranking is n=4, therefore:
Area A's AGI=3/4=0.7500
Area B's AGI=1/4=0.2500
Area C's AGI=2/4=0.5000
Area D's AGI=4/4=1.0000

The user interface 18 may generate at least one data entry field for a user to directly input a preferred value or preferred range of values of one or more indices. For example, the user interface may generate a data entry field for a user to directly input a minimum value of the area growth index (AGI), or alternatively or additionally, a maximum value of the AGI. The index generation module 22 may use this input as another way to select properties for which the property compatibility index will be generated. For example, if a user specifies a preference for properties with an AGI of at least 0.6, the index generation module 22 may not generate the property compatibility index for properties with an AGI below 0.6. This may save computing time and reduce the waiting time for the user.

### Property Demand Index (PDI)

The index generation module 22 may generate, for selected properties, a property demand index (PDI) indicative of perceived demand for each particular property. The PDI may be independent of preferences of the purchaser. There are many ways in which a PDI may be generated. Generally any suitable method, even simple ones, may be used. The following is only one example. The PDI is based on a subset of the property data. In this example, the subset of the property data used in the generation of the PDI includes, but is not limited to the following property demand factors:
property affordability rating (consider price of property as a percentage of area household income);
property demand type (consider type of property which is in demand for the area);
property amenity rating (consider rating of the accessibility to essential amenities such as shops, schools, transport, beach etc.);
property renter demand (consider property dominated by renters—type, size, bedrooms, bathrooms);
property undervalued (consider similar property in adjacent, or two adjacent, suburb);
property price low segment (consider whether the property is in a lower segment of the market and has a better opportunity for growth & lower risk);
days on market for property type; and
vacancy for property type.

In this example, a numerical score is generated for each of the property demand factors based on predetermined rules. Generally any suitable rules, even simple ones, may be used. The scores for all the property demand factors of a property are then added to produce a property demand score (PDS) for that property. The same scoring process is used for all other non-excluded properties i.e. a PDS is generated for all properties being considered by the purchaser. All of the PDS values are then ranked from highest to lowest, with the lowest ranking being 1, and the highest ranking being n. The PDI for an area is its PDS ranking divided by n.

### EXAMPLE

If property A had a PDS=0.3423, property B had a PDS=0.4976, property C had a PDS=0.4396 and property D had a PDS=0.3428, then:
property A's ranking of PDS=1,
property B's ranking of PDS=4,
property C's ranking of PDS=3,
property D's ranking of PDS=2.
The highest ranking is n=4, therefore:
property A's PDI=1/4=0.2500
property B's PDI=4/4=1.0000
property C's PDI=3/4=0.7500
property D's PDI=2/4=0.5000

### Property Growth Index (PGI)

The index generation module 22 may generate, for selected properties, a property growth index (PGI) indicative of capital growth for each particular property. There are many ways in which a PGI may be generated. Generally any suitable method, even simple ones, may be used. The following is only one example. In this example, PGI is a function of the area growth index (AGI) and the property demand index (PDI).

In this example, selected properties are ranked first according to their AGI, and then according to their PDI. For example, if two properties have the same PDI, then the property with the highest AGI will be ranked highest and therefore given the highest PGI. The properties are then assigned a rank, with the lowest ranking being 1, and the highest ranking being n. The PGI for a property is its rank divided by n.

### EXAMPLE

If property A had a PDI=0.8454 and was in an Area where AGI=0.5649:
property B had an PDI=0.4567 and was in an Area where AGI=0.5649,
property C had an PDI=0.6867 and was in an Area where AGI=0.5649,
property D had an PDI=0.6767 and was in an Area where AGI=0.6649,
property E had an PDI=0.7896 and was in an Area where AGI=0.6649,
property F had an PDI=0.4896 and was in an Area where AGI=0.6649, so:
property A's ranking=3,
property B's ranking=1,
property C's ranking=2,
property D's ranking=5,
property F's ranking=4
The highest ranking is n=6 therefore:
property A's PGI=3/6=0.5000
property B's PGI=1/6=0.1666
property C's PGI=2/6=0.3333
property D's PGI=5/6=0.8333
property E's PGI=6/6=1.0000
property F's PGI=4/6=0.6666

### Purchaser Cash Flow Index (PCFI)

The index generation module 22 may generate, for selected properties, a purchaser cash flow index (PCFI) indicative of a purchaser's expected cash flow, should they purchase a particular property. There are many ways in which a PCFI may be generated. Generally, any suitable method, even simple ones, may be used. The following is only one example.

The index generation module 22 generates a purchaser cash flow score (PCFS) for each selected property, using the purchaser data and the property data. The PCFS is indicative of the purchaser's expected available after-tax cash flow if a particular property is purchased.

In this example, selected properties are first ranked according to the value of their PCS. The properties are then assigned a rank based on the PCS, with the lowest ranking being 1, and the highest ranking being n. The PCFI for a property is its rank divided by n.

### EXAMPLE

If property A had PCFS=5.76, property B had PCFS=−2.41, and property C had an PCFS=0.15, then
property A's ranking of PCFS=3,
property B's ranking of PCFS=1,
property C's ranking of PCFS=2
The highest ranking is n=3, therefore:
property A's PCFI=3/3=1.0000
property B's PCFI=1/3=0.3333
property C's PCFI=2/3=0.6666

### Property Compatibility Index (PCI)

The index generation module 22 may use at least one other index and at least one other weighting to generate, for selected properties, a property compatibility index (PCI). Ideally, the PCI is an indicator of a degree of compatibility between the property and the purchaser: a higher PCI is suggestive of greater compatibility. There are many ways in which the PCI may be generated. Any suitable method may be used, including simple ones. The following is only one example.

In this example, the purchaser cash flow index (PCFI) disclosed above and property growth index (PGI) disclosed above are weighted according to the purchaser's preference for cash flow versus capital growth. The cash flow weighting factor (CW) and growth weighting factor (GW) generated by the slider 32 may be used to apply the weightings to PCFI and PGI, for example:

PCI=(PCFI×CW)+(PGI×GW)
For example, if a property has PCFI=0.5676 and PGI=0.6750, and the purchaser's preference is CW=0.25 and GW=0.75, then:

PCI=(0.5676×0.25)+(0.6750×0.75)=0.1419+0.5062=0.6481
PCI=0.6481

The list generation module 24 may use the property compatibility index (PCI) to generate a list of selected properties in which properties are ranked by PCI from lowest PCI (least compatible) to highest PCI (highest compatibility).

The PCI may also be a function of an ability of the purchaser to qualify for finance, for example a mortgage, from a financier to purchase each real property. For example, the PCI for a property may be reduced if the purchaser is unlikely to qualify for finance to purchase the property. In one example, the index generation module 22 generates a binary weighting factor (1 or 0) and uses the weighting factor in the generation of PCI. For example:

PCI=FW((PCFI×CW)+(PGI×GW)),

and where:
FW=finance weighting (FW=1 if the purchaser is satisfies a financier's finance qualification criteria, or if the purchaser does not require finance; FW=0 if the purchaser requires finance but does not satisfy a financier's finance qualification criteria).

In this example, the PCI will be zero if the purchaser is unlikely to qualify for finance. This helps purchasers by eliminating properties for which they cannot obtain finance and giving a higher rank to properties for which they are likely to obtain finance.

There are many ways in which the index generation module 22 may determine whether a purchaser will qualify for finance. Known qualification criteria of financiers for real property may be used. In one example, the qualification criteria comprise:
LVR qualification: the loan-to-valuation ratio of the property must be less than a predetermined value set by the financier; and
serviceability qualification: the financier must be satisfied about the ability of the purchaser to service a loan for the property.

In this example, if the property satisfies both the LVR qualification and the serviceability qualification (or if the purchaser does not require finance), then FW=1. Otherwise, FW=0.

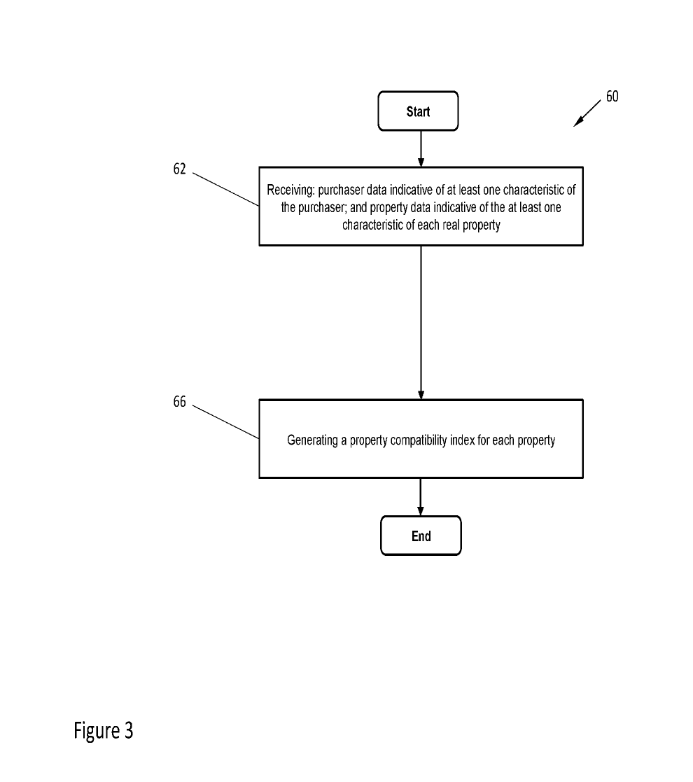

FIG. 3 is a flow diagram of an embodiment of a method 60 for ranking a plurality of real properties on offer. The steps will be described with reference to the system 10 described above with reference FIGS. 1 to 3.

Step 62 comprises receiving: purchaser data indicative of at least one characteristic of the purchaser; and property data indicative of the at least one characteristic of each real property.

Step 66 comprises generating a property compatibility index for each property.

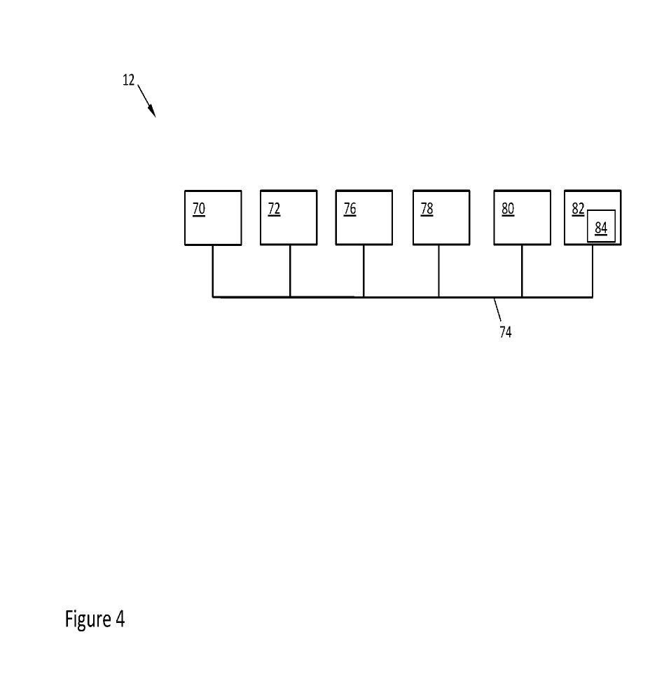

FIG. 4 shows a schematic diagram of the architecture of an embodiment of the processor 12. In this embodiment, software is stored in nonvolatile memory 70 in the form of FLASH, but could be stored in a hard drive, EPROM or any other form of tangible media within or external to the processor 12. The software generally, but not necessarily, comprises a plurality of software modules that cooperate when installed on the processor 12. Functions or components 20-24, for example, may be compartmentalized into software and/or hardware modules or may be fragmented across several software and/or hardware modules. The software modules may be formed using any suitable language, examples of which include C++, JAVA and assembly. The program may take the form of an application program interface or any other suitable software structure. The processor 12 includes a suitable microprocessor 72 (for example an Intel, ARM or AMD processor) connected by a bus 74 to random access memory 76 of around 2 GB and non-volatile memory for example a hard disk drive 78 or solid state non-volatile memory having a capacity of around 100 GB. The processor 12 has input/output interfaces 80 which may include one or more network interfaces such interface 20, and a universal serial bus. Communication with the processor 12 may be made using, for example, a web browser interface via interfaces 80. An alternative example of a suitable processor may support a human machine interface 82 (“user interface”) e.g. mouse, keyboard, display, trackpad, touchscreen etc. The components 70-82 may communicate via a bus 74.

Variations and/or modifications may be made to the embodiments described without departing from the spirit or ambit of the invention. For example, an embodiment of a system for ranking a plurality of real properties on offer may comprise property database 14 and the purchaser database 16. In an embodiment, the processor interface comprises the user interface. The present embodiments are, therefore, to be considered in all respects as illustrative and not restrictive.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

### APPENDIX 1

Example of a risk profile questionnaire and scoring system:

1. How would you describe yourself?
1. Retired and dependent on existing funds and/or pensions for income.
2. With a family to support. While you understand the need to invest, you cannot see how it will be possible, as your income is fully committed to the family budget
3. Easily managing your current financial commitments. Your current income provides an acceptable lifestyle. You may be just starting out on your career or be well-established.
4. At the peak of your career and income, possibly with a dual income. You have no dependents and/or easily manage the expense needs of your dependents.

2. What is your understanding of investing in property?
1. Not very familiar with it
2. You understand the need to invest, but little more.
3. You understand how different property types can produce differing income and growth.
4. You are an experienced investor with a current property portfolio.

3. What are your financial goals?
1. Income from an investment is the most important outcome for you.
2. Safety is the most important feature for you.
3. You have a specific timeframe of, for example, five years and a set return you would like to achieve in that time.
4. Growth is the most important outcome for you.

4. If your investment property was to suddenly lose value by 20%, what would your reaction be?
1. You would sell up immediately and never invest in property again.
2. You would keep what you had but not buy anymore.
3. You would be concerned but would wait and see for a while before you invested again.
4. You would not be concerned—you might even invest more in the same area while you can get a bargain!

5. Which do you prefer?
1. Stable though relatively low returns.
2. Consistent returns with minimal tax savings.
3. Variable returns with good tax savings.
4. Higher returns with maximum tax savings (but higher risk).

6. When do you plan to retire?
1. Already retired.
2. Within five years.
3. In 5 to 15 years.
4. In more than 15 years.

7. How often would you sell your property?
1. Never.
2. Within 10 years.
3. Every time there is a substantial gain.
4. Every year or two.

8. In relation to buying property sight-unseen, you feel:
1. You simply could not do it
2. You may be able to do it if you had lots of pictures.
3. You would be happy to do so if you had someone you could trust to go and look at the property on your behalf
4. You don't need to see it at all as long as the figures stack up.
   Use the following formula to add up your score
For every 1 answer, score one point.
For every 2 answer, score two points.
For every 3 answer, score three points.
For every 4 answer, score four points.

### Your Results:

7-13 points: Conservative:
You are a conservative investor who is risk adverse.
You are prepared to sacrifice higher returns for peace of mind.
You have a short-term investment period in which income and preserving your capital is of prime concern.
You should only invest in low risk property which includes standard residential property in well populated city suburbs or large regional towns.
You should ensure a low loan-to-valuation ratio′ (LVR), around 50-60 per cent
   14-20 points: Stable:
You are a stable investor who is prepared to accept a small amount of risk.
You are willing to take a small degree of short-term risk if it means the chance of long-term returns.
Your investment term is three to five years.
Security is very important to you though, and income is more important than growth.
You should buy standard residential with a positive cash flow, and with sufficient research you may be able to buy in smaller towns with evidence of economic vibrancy such as mining towns.
You can set your LVR between 60-80%.
   21-27 points: Balanced:
You are a balanced investor and have comfort with a moderate amount of risk.
You have a relatively long period in which to invest
You are comfortable with short-term volatility for long-term growth and income.
You would like some security but are prepared to take some risk.
You usually invest in standard residential, and could invest short tern holiday let with standard management and some commercial premises such as offices with evidence of high demand and a positive cash flow.
You can comfortably set your LVR at 80%.
   28-32 points: Assertive:
You are an assertive investor who is comfortable with higher levels of risk.
You look for growth investments and are willing to include some speculative investments.
You can cope with negative returns and increased volatility.
Capital growth is your prime concern.
You can invest in most types of property including inner city apartments or niche market properties such as serviced apartments and retirement villages (high income) as well as commercial properties including factories and warehouses.
High income earners with a sufficient surplus may accept negative cash flow.
You could stand up to a 90% LVR if necessary.

1. A method for determining the compatibility of a purchaser with a plurality of real properties on offer, the method comprising excluding those of the plurality of real properties on offer that match at least one exclusion criterion, and using a plurality of characteristics to generate, for each of the non-excluded ones of the plurality of real properties on offer, a property compatibility index indicative of a degree of compatibility between the corresponding real property and the purchaser, wherein the plurality of characteristics comprises at least one characteristic of the purchaser and at least one characteristic of each of the non-excluded ones of the plurality of real properties on offer.

2. A method defined by claim 1, wherein the plurality of characteristics further comprises loan qualification characteristics indicative of a probability that the purchaser will qualify for finance for each of the non-excluded ones of the plurality of real properties on offer.

3. A method defined by claim 1 comprising the steps of:
a processor interface of a processor receiving: purchaser data indicative of the at least one characteristic of the purchaser; and property data indicative of the at least one characteristic of each of the plurality of real properties; and
an index generation module of the processor generating the property compatibility index for each of the non-excluded ones of the plurality of real properties on offer, the property compatibility index for each of the non-excluded ones of the plurality of real properties on offer being generated using the property data and the purchaser data.

4. A method defined by claim 3 in combination with claim 2, wherein the processor interface further receives finance data indicative of the loan qualification characteristics, and wherein the index generation modules uses the finance data to generate the property compatibility index.

5. A method defined by any one of claims 3 to 4, wherein a user interface is operated to specify a plurality of weighting factors, and comprising the step of weighting a plurality of other indexes with the plurality of weighting factors and using the plurality of other indexes so weighted to generate the property compatibility index for each of the non-excluded ones of the plurality of real properties on offer.

6. A method defined by claim 5, wherein the user interface constrains the plurality of weighting factors such that a sum of the plurality of weighting factors remains constant.

7. A method defined by either one of claim 5 and claim 6, wherein the user interface generates: a graphic indicative of the sum of the plurality of weighting factors; and a marker operable for a user to divide the graphic into a plurality of portions, each portion being indicative of a magnitude of each of the plurality of weighting factors.

8. A method defined by any one of claims 3 to 7, wherein the step of generating the property compatibility index for each of the non-excluded ones of the plurality of real properties comprises the steps of:
generating at least one local area index indicative of at least one characteristic of a local area in which each of the non-excluded ones of the plurality of properties is located;
generating at least one property site index indicative of at least one characteristic of a property site included in the real property on offer; and
weighting at least one of the local area index and the property site index by one or more of the plurality of weighting factors.

9. A method defined by any one of claims 5 to 8, wherein the user interface is operated to input at least one response to a questionnaire, the at least one response being indicative of the at least one characteristic of the purchaser, and the step of generating the property compatibility index comprises the steps of:
determining at least one score indicative of the at least one response; and
including the at least one score in the generation of the property compatibility index.

10. A method defined by any one of the claims 5 to 9, wherein the user interface is a graphical user interface.

11. A method defined by any one of claims 3 to 10 further comprising a step of:
generating a list of properties comprising the non-excluded ones of the plurality of real properties on offer ranked in order of compatibility index.

12. A method defined by any one of claims 3 to 11, wherein the at least one characteristic of the purchaser is selected from a group comprising:
a date of birth of the purchaser;
a date of birth of each dependent of the purchaser;
a risk profile of the purchaser;
gross annual personal taxable income received by the purchaser;
annual salary sacrifice made by the purchaser;
annual government benefits received by the purchaser;
annual non-taxable income received by the purchaser;
annual personal expenses of the purchaser;
annual rental expenses of the purchaser;
total limit on each credit card of the purchaser;
non-property annual investment expenses of the purchaser;
for each additional property in an existing portfolio of the purchaser, a settlement date of the additional property;
for each additional property in an existing portfolio of the purchaser, an original purchase price of the additional property;
for each additional property in an existing portfolio of the purchaser, an address of the additional property;
for each additional property in an existing portfolio of the purchaser, a current market value of the additional property;
for each additional property in an existing portfolio of the purchaser, whether the additional property is for a personal or investment purpose;
for each additional property in an existing portfolio of the purchaser, a percentage ownership allocation of the additional property;
for each additional property in an existing portfolio of the purchaser, an annual rental income of the additional property;
for each additional property in an existing portfolio of the purchaser, a maximum loan-to-valuation ratio permitted by the purchaser for the additional property;
for each additional property in an existing portfolio of the purchaser, a current loan balance of the additional property;
for each additional property in an existing portfolio of the purchaser, an annual loan interest payable for the additional property;
for each additional property in an existing portfolio of the purchaser, an amount of annual total expenses payable, for the additional property, excluding mortgage interest expenses;
for each additional property in an existing portfolio of the purchaser, any deductions for borrowing, plant, and capital works for the additional property;
for each additional mortgage in an existing portfolio of the purchaser, a financier for the additional mortgage;
for each additional mortgage in an existing portfolio of the purchaser, a type of the additional mortgage;
for each mortgage in an existing portfolio of the purchaser, whether the additional mortgage is for a personal or investment purpose;
for each additional mortgage in an existing portfolio of the purchaser, a redraw limit of the additional mortgage;
for each additional mortgage in an existing portfolio of the purchaser, a current balance of the additional mortgage;
for each additional mortgage in an existing portfolio of the purchaser, a current interest rate of the additional mortgage;
for each additional mortgage in an existing portfolio of the purchaser, whether an interest rate for the additional mortgage is fixed or variable;
for each mortgage in an existing portfolio of the purchaser, a date on which a fixed-interest rate period for the additional mortgage ends;
for each fixed-interest rate mortgage in an existing portfolio of the purchaser, an amount of a penalty for discharging the additional mortgage before a fixed-interest rate period ends;
for each mortgage in an existing portfolio of the purchaser, an amount of a penalty payable if the additional mortgage is discharged early;
for each additional mortgage in an existing portfolio of the purchaser, a current amount payable for the additional mortgage;
for each additional mortgage in an existing portfolio of the purchaser, a frequency of payments for the additional mortgage;
for each additional mortgage in an existing portfolio of the purchaser, any annual account fees payable for the additional mortgage;
for each additional mortgage in an existing portfolio of the purchaser, a date on which a term of the additional mortgage ends;
for each additional loan of the purchaser, not including any loan for additional property in a portfolio of the purchaser, a financier of the additional loan;
for each additional loan of the purchaser, not including any loan for additional property in a portfolio of the purchaser, a type of the additional loan;
for each additional loan of the purchaser, not including any loan for additional property in a portfolio of the purchaser, whether the additional loan is for a personal or investment purpose;
for each additional loan of the purchaser, not including any loan for additional property in a portfolio of the purchaser, a redraw limit of the additional loan;
for each additional loan of the purchaser, not including any loan for additional property in a portfolio of the purchaser, a current balance of the additional loan;
for each additional loan of the purchaser, not including any loan for additional property in a portfolio of the purchaser, a current interest rate of the additional loan;
for each additional loan of the purchaser, not including any loan for additional property in a portfolio of the purchaser, whether an interest rate of the additional loan is fixed or variable;
for each additional loan of the purchaser, not including any loan for additional property in a portfolio of the purchaser, a date on which a fixed-interest rate period ends;
for each additional fixed-interest rate loan of the purchaser, not including any loan for additional property in a portfolio of the purchaser, an amount of a penalty for discharging the additional loan before a fixed-interest rate period ends;
for each additional loan of the purchaser, not including any loan for additional property in a portfolio of the purchaser, any amount of any penalty payable if the additional loan is discharged early;
for each additional loan of the purchaser, not including any loan for additional property in a portfolio of the purchaser, a current payment amount of the additional loan;
for each additional loan of the purchaser, not including any loan for additional property in a portfolio of the purchaser, a frequency of payments for the additional loan; and
for each additional loan of the purchaser, not including any loan for additional property in a portfolio of the purchaser, an amount of any annual account fees on the additional loan.

13. A method defined by any one of claims 3 to 12, wherein the property data indicative of the at least one characteristic of each of the non-excluded ones of the real properties on offer is selected from a group comprising:
an address of the real property;
a suburb in which the real property is located;
a state in which the real property is located;
a postcode for the real property;
a local government area for the real property;
a set of map coordinates for the real property;
a total number of bedrooms included in the real property;
a total number of bathrooms included in the real property;
a total number of car spaces included in the real property;
a size of a land component of the real property;
a housing type classification for the real property;
a market value of the real property;
a value of costs associated with purchasing the real property;
a value of annual costs associated with owning the real property;
a rental income of the real property;
a future deduction information for the real property for 40 years;
an original asking price for the real property;
a current asking price for the real property;
a date on which the real property was listed for sale.
a percentage of a local population who live in a local area in which the real property is located and are aged between 0-17 years, 18-24 years, 25-54 years, 55-65 years, 66+ years;
a percentage of a local population who live in a local area in which the real property is located and rent accommodation;
a total number of people who have resided over the last five years in a local area in which the real property is located;
a percentage of a local population who live in a local area in which the real property is located and who are unemployed;
a median household income of a local population who live in a local area in which the real property is located;
a median household debt of a local population who live in a local area in which the real property is located;
a median house sale price for a local area in which the real property is located;
a median unit sale price for a local area in which the real property is located;
a median land price for a local area in which the real property is located;
a median commercial sale price for a local area in which the real property is located;
a median property price for a local area in which the real property is located;
a median rent for houses in a local area in which the real property is located;
a median rent for commercial properties in a local area in which the real property is located;
a median rent for all properties in a local area in which the real property is located;
a total number of residential and commercial land lots available in a local area in which the real property is located;
a total number of development approvals for houses in a local area in which the real property is located;
a total number of development approvals for units in a local area in which the real property is located;
a total number of development approvals for commercial properties in a local area in which the real property is located;
an average time for developments to be approved in a local area in which the real property is located;
a total number of members per household in a local area in which the real property is located;
a total number of established house dwellings in a local area in which the real property is located;
a total number of established unit dwellings in a local area in which the real property is located;
a total number of established commercial premises in a local area in which the real property is located;
a percentage of properties which are rented in a local area in which the real property is located;
a percentage of properties having no mortgage in a local area in which the real property is located;
a percentage of properties which are mortgaged in a local area in which the real property is located;
a percentage of houses which are vacant in a local area in which the real property is located;
a percentage of units which are vacant in a local area in which the real property is located;
a percentage of commercial properties which are vacant in a local area in which the real property is located;
a total number of houses on offer for sale in a local area in which the real property is located;
a total number of lots of land on offer for sale in a local area in which the real property is located;
a total number of commercial properties on offer for sale in a local area in which the real property is located;
a total number of units available for rent in a local area in which the real property is located;
a total number of houses available for rent in a local area in which the real property is located;
a total number of commercial properties available for rent in a local area in which the real property is located;
a median property size in a local area in which the real property is located;
a total number of houses sold over the last 12 months in a local area in which the real property is located;
a total number of units sold over the last 12 months in a local area in which the real property is located;
a total number of commercial properties sold over the last 12 months in a local area in which the real property is located;
a percentage yield for all properties in a local area in which the real property is located;
a percentage yield for houses in a local area in which the real property is located;
a percentage yield for units in a local area in which the real property is located;
a percentage yield for commercial properties in a local area in which the real property is located;
a yield per square metre for all properties in a local area in which the real property is located;
a percentage of properties which are houses in a local area in which the real property is located;
a percentage of properties which are units in a local area in which the real property is located;
a mortgage delinquency rating for a local area in which the real property is located;
a total number of property starts in a local area in which the real property is located;
a crime rate for a local area in which the real property is located;
a consumer price index in a local area in which the real property is located;
a gross domestic product in a country in which the real property is located;
an employment vulnerability index for a local area in which the real property is located;
an average number of years a resident stays in a local area in which the real property is located;
a total number of residential properties on offer for sale in a local area in which the real property is located;
an average number of days that properties are on offer for sale in a local area in which the real property is located;
an average percentage that properties are discounted when sold in a local area in which the real property is located;
a total number of properties on offer within price deviation of $50,000 in a local area in which the real property is located;
a value of any funded planned infrastructure developments in a local area in which the real property is located;
a growth of employment in a local area in which the real property is located;
any indicators of business growth in a local area in which the real property is located;
types of transport road, rail and port links available in a local area in which the real property is located;
any commercial infrastructure funding in a local area in which the real property is located;
a rental cost per square metre of commercial space in a local area in which the real property is located;
a ratio of population to a total number of dwellings in a local area in which the real property is located;
a cost per square metre of housing construction in a local area in which the real property is located;
a level at which financiers will fund properties in a local area in which the real property is located;
a cost of living in a local area in which the real property is located;
an energy tariff rate in a local area in which the real property is located;
a total population in a local area in which the real property is located; and
a measure of diversification of industry in a local area in which the real property is located.

14. A method defined by claim 4, wherein the finance data indicative of the loan qualification characteristics comprises:
a financier's first qualification criteria for loan-to-valuation ratio in relation to finance for each of the non-excluded ones of the plurality of real properties on offer;
a financier's second qualification criteria for an ability of the purchaser to service a loan to purchase each of the non-excluded ones of the plurality of real properties on offer.

15. A method defined by any one of the claims 3 to 14 wherein the processor interface comprises a processor-network interface.

16. A system for determining the compatibility of a purchaser with a plurality of real properties on offer, the system being arranged to exclude those of the plurality of real properties on offer that match at least one exclusion criterion, and to use a plurality of characteristics to generate, for each of the non-excluded ones of the plurality of real properties on offer, a property compatibility index indicative of a degree of compatibility between the corresponding real property and the purchaser, wherein the plurality of characteristics comprises at least one characteristic of the purchaser and at least one characteristic of each of the non-excluded ones of the plurality of real properties on offer.

17. A system defined by claim 16, wherein the plurality of characteristics further comprises loan qualification characteristics indicative of a probability that the purchaser will qualify for finance for each of the non-excluded ones of the plurality of real properties on offer.

18. A system defined by claim 16 comprising:
a processor interface of a processor arranged to receive: purchaser data indicative of the at least one characteristic of the purchaser; and property data indicative of the at least one characteristic of each of the plurality of real properties;
a real property exclusion module arranged to exclude those of the real properties on offer that match at least one exclusion criterion; and
an index generation module of the processor arranged to generate the property compatibility index for each of the non-excluded ones of the plurality of properties on offer, the property compatibility index for each of the non-excluded ones of the plurality of real properties on offer being generated using the property data and the purchaser data.

19. A system defined by claim 18 in combination with claim 17, wherein the processor interface is further arranged to receive finance data indicative of the loan qualification characteristics, and wherein the index generation module is arranged to generate the property compatibility index using the finance data for each of the non-excluded ones of the plurality of real properties on offer.

20. A system defined by any one of claims 18 to 19 comprising a user interface operable for a user to specify a plurality of weighting factors, the index generation module being arranged to weight a plurality of other indexes with the plurality of weighting factors and using the plurality of other indexes so weighted to generate the property compatibility index.

21. A system defined by claim 20, wherein the user interface is arranged to constrain the plurality of weighting factors such that a sum of the plurality of weighting factors remains constant.

22. A system defined by one claim 21, wherein the user interface is arranged to generate: a graphic indicative of the sum of the plurality of weighting factors; and a marker operable for a user to divide the graphic into a plurality of portions, each portion being indicative of a magnitude of each of the plurality of weighting factors.

23. A system defined by any one of claims 20 to 22, wherein the user interface is operable for a user to input at least one response to a questionnaire, and the index generation module is arranged to:
determine at least one score indicative of the at least one response; and
include the at least one score in the generation of the property compatibility index for each of the non-excluded ones of the plurality of real properties on offer.

24. A system defined by one of the claims 20 to 23, wherein the user interface is a graphical user interface.

25. A system defined by any one of claims 20 to 24, wherein the index generation module is arranged to:
generate at least one local area index indicative of at least one characteristic of a local area in which each of the non-excluded ones of the plurality of properties is located;
generate at least one property site index indicative of at least one characteristic of a property site included in the real property on offer; and
weight at least one of the local area index and the property site index by one or more of the plurality of weighting factors.

26. A system defined by any one of claims 16 to 25, wherein the system further comprises:
a list generation module arranged to generate a list of properties comprising the non-excluded ones of the plurality of real properties ranked in order of compatibility index.

27. A system defined by any one of claims 18 to 26, wherein the at least one characteristic of the purchaser is selected from a group comprising:
a date of birth of the purchaser;
a date of birth of each dependent of the purchaser;
a risk profile of the purchaser;
gross annual personal taxable income received by the purchaser;
annual salary sacrifice made by the purchaser;
annual government benefits received by the purchaser;
annual non-taxable income received by the purchaser;
annual personal expenses of the purchaser;
annual rental expenses of the purchaser;
total limit on each credit card of the purchaser;
non-property annual investment expenses of the purchaser;
for each additional property in an existing portfolio of the purchaser, a settlement date of the additional property;
for each additional property in an existing portfolio of the purchaser, an original purchase price of the additional property;
for each additional property in an existing portfolio of the purchaser, an address of the additional property;
for each additional property in an existing portfolio of the purchaser, a current market value of the additional property;
for each additional property in an existing portfolio of the purchaser, whether the additional property is for a personal or investment purpose;
for each additional property in an existing portfolio of the purchaser, a percentage ownership allocation of the additional property;
for each additional property in an existing portfolio of the purchaser, an annual rental income of the additional property;
for each additional property in an existing portfolio of the purchaser, a maximum loan-to-valuation ratio permitted by the purchaser for the additional property;
for each additional property in an existing portfolio of the purchaser, a current loan balance of the additional property;
for each additional property in an existing portfolio of the purchaser, an annual loan interest payable for the additional property;
for each additional property in an existing portfolio of the purchaser, an amount of annual total expenses payable, for the additional property, excluding mortgage interest expenses;
for each additional property in an existing portfolio of the purchaser, any deductions for borrowing, plant, and capital works for the additional property;
for each additional mortgage in an existing portfolio of the purchaser, a financier for the additional mortgage;
for each additional mortgage in an existing portfolio of the purchaser, a type of the additional mortgage;
for each mortgage in an existing portfolio of the purchaser, whether the additional mortgage is for a personal or investment purpose;
for each additional mortgage in an existing portfolio of the purchaser, a redraw limit of the additional mortgage;
for each additional mortgage in an existing portfolio of the purchaser, a current balance of the additional mortgage;
for each additional mortgage in an existing portfolio of the purchaser, a current interest rate of the additional mortgage;
for each additional mortgage in an existing portfolio of the purchaser, whether an interest rate for the additional mortgage is fixed or variable;
for each mortgage in an existing portfolio of the purchaser, a date on which a fixed-interest rate period for the additional mortgage ends;
for each fixed-interest rate mortgage in an existing portfolio of the purchaser, an amount of a penalty for discharging the additional mortgage before a fixed-interest rate period ends;
for each mortgage in an existing portfolio of the purchaser, an amount of a penalty payable if the additional mortgage is discharged early;
for each additional mortgage in an existing portfolio of the purchaser, a current amount payable for the additional mortgage;
for each additional mortgage in an existing portfolio of the purchaser, a frequency of payments for the additional mortgage;
for each additional mortgage in an existing portfolio of the purchaser, any annual account fees payable for the additional mortgage;
for each additional mortgage in an existing portfolio of the purchaser, a date on which a term of the additional mortgage ends;
for each additional loan of the purchaser, not including any loan for additional property in a portfolio of the purchaser, a financier of the additional loan;
for each additional loan of the purchaser, not including any loan for additional property in a portfolio of the purchaser, a type of the additional loan;
for each additional loan of the purchaser, not including any loan for additional property in a portfolio of the purchaser, whether the additional loan is for a personal or investment purpose;
for each additional loan of the purchaser, not including any loan for additional property in a portfolio of the purchaser, a redraw limit of the additional loan;
for each additional loan of the purchaser, not including any loan for additional property in a portfolio of the purchaser, a current balance of the additional loan;
for each additional loan of the purchaser, not including any loan for additional property in a portfolio of the purchaser, a current interest rate of the additional loan;
for each additional loan of the purchaser, not including any loan for additional property in a portfolio of the purchaser, whether an interest rate of the additional loan is fixed or variable;
for each additional loan of the purchaser, not including any loan for additional property in a portfolio of the purchaser, a date on which a fixed-interest rate period ends;
for each additional fixed-interest rate loan of the purchaser, not including any loan for additional property in a portfolio of the purchaser, an amount of a penalty for discharging the additional loan before a fixed-interest rate period ends;
for each additional loan of the purchaser, not including any loan for additional property in a portfolio of the purchaser, any amount of any penalty payable if the additional loan is discharged early;
for each additional loan of the purchaser, not including any loan for additional property in a portfolio of the purchaser, a current payment amount of the additional loan;
for each additional loan of the purchaser, not including any loan for additional property in a portfolio of the purchaser, a frequency of payments for the additional loan; and
for each additional loan of the purchaser, not including any loan for additional property in a portfolio of the purchaser, an amount of any annual account fees on the additional loan.

28. A system defined by any one of claims 18 to 27, wherein the at least one characteristic each of the non-excluded ones of the plurality of real properties on offer is selected from a group comprising:
an address of the real property;
a suburb in which the real property is located;
a state in which the real property is located;
a postcode for the real property;
a local government area for the real property;
a set of map coordinates for the real property;
a total number of bedrooms included in the real property;
a total number of bathrooms included in the real property;
a total number of car spaces included in the real property;
a size of a land component of the real property;
a housing type classification for the real property;
a market value of the real property;
a value of costs associated with purchasing the real property;
a value of annual costs associated with owning the real property;
a rental income of the real property;
a future deduction information for the real property for 40 years;
an original asking price for the real property;
a current asking price for the real property;
a date on which the real property was listed for sale.
a percentage of a local population who live in a local area in which the real property is located and are aged between 0-17 years, 18-24 years, 25-54 years, 55-65 years, 66+ years;
a percentage of a local population who live in a local area in which the real property is located and rent accommodation;
a total number of people who have resided over the last five years in a local area in which the real property is located;
a percentage of a local population who live in a local area in which the real property is located and who are unemployed;
a median household income of a local population who live in a local area in which the real property is located;
a median household debt of a local population who live in a local area in which the real property is located;
a median house sale price for a local area in which the real property is located;
a median unit sale price for a local area in which the real property is located;
a median land price for a local area in which the real property is located;
a median commercial sale price for a local area in which the real property is located;
a median property price for a local area in which the real property is located;
a median rent for houses in a local area in which the real property is located;
a median rent for units in a local area in which the real property is located;
a median rent for commercial properties in a local area in which the real property is located;
a median rent for all properties in a local area in which the real property is located;
a total number of residential and commercial land lots available in a local area in which the real property is located;
a total number of development approvals for houses in a local area in which the real property is located;
a total number of development approvals for units in a local area in which the real property is located;
a total number of development approvals for commercial properties in a local area in which the real property is located;
an average time for developments to be approved in a local area in which the real property is located;
a total number of members per household in a local area in which the real property is located;
a total number of established house dwellings in a local area in which the real property is located;
a total number of established unit dwellings in a local area in which the real property is located;
a total number of established commercial premises in a local area in which the real property is located;
a percentage of properties which are rented in a local area in which the real property is located;
a percentage of properties having no mortgage in a local area in which the real property is located;
a percentage of properties which are mortgaged in a local area in which the real property is located;
a percentage of houses which are vacant in a local area in which the real property is located;
a percentage of units which are vacant in a local area in which the real property is located;
a percentage of commercial properties which are vacant in a local area in which the real property is located;
a total number of houses on offer for sale in a local area in which the real property is located;
a total number of lots of land on offer for sale in a local area in which the real property is located;
a total number of commercial properties on offer for sale in a local area in which the real property is located;
a total number of units available for rent in a local area in which the real property is located;
a total number of houses available for rent in a local area in which the real property is located;
a total number of commercial properties available for rent in a local area in which the real property is located;
a median property size in a local area in which the real property is located;
a total number of houses sold over the last 12 months in a local area in which the real property is located;
a total number of units sold over the last 12 months in a local area in which the real property is located;
a total number of commercial properties sold over the last 12 months in a local area in which the real property is located;
a percentage yield for all properties in a local area in which the real property is located;
a percentage yield for houses in a local area in which the real property is located;
a percentage yield for units in a local area in which the real property is located;
a percentage yield for commercial properties in a local area in which the real property is located;
a yield per square metre for all properties in a local area in which the real property is located;
a percentage of properties which are houses in a local area in which the real property is located;
a percentage of properties which are units in a local area in which the real property is located;
a mortgage delinquency rating for a local area in which the real property is located;
a total number of property starts in a local area in which the real property is located;
a crime rate for a local area in which the real property is located;
a consumer price index in a local area in which the real property is located;
a gross domestic product in a country in which the real property is located;
a gross regional product in a local area in which the real property is located;
an employment vulnerability index for a local area in which the real property is located;
an average number of years a resident stays in a local area in which the real property is located;
a total number of residential properties on offer for sale in a local area in which the real property is located;
an average number of days that properties are on offer for sale in a local area in which the real property is located;
an average percentage that properties are discounted when sold in a local area in which the real property is located;
a total number of properties on offer within price deviation of $50,000 in a local area in which the real property is located;
a value of any funded planned infrastructure developments in a local area in which the real property is located;
a growth of employment in a local area in which the real property is located;
any indicators of business growth in a local area in which the real property is located;
types of transport road, rail and port links available in a local area in which the real property is located;
any commercial infrastructure funding in a local area in which the real property is located;
a rental cost per square metre of commercial space in a local area in which the real property is located;
a ratio of population to a total number of dwellings in a local area in which the real property is located;
a cost per square metre of housing construction in a local area in which the real property is located;
a level at which financiers will fund properties in a local area in which the real property is located;
a cost of living in a local area in which the real property is located;
an energy tariff rate in a local area in which the real property is located;
a total population in a local area in which the real property is located; and
a measure of diversification of industry in a local area in which the real property is located.

29. A system defined by claim 19, wherein the finance data indicative of the loan qualification characteristics comprises:
a financier's first qualification criteria for loan-to-valuation ratio in relation to finance for each of the non-excluded ones of the plurality of real properties on offer;
a financier's second qualification criteria for an ability of the purchaser to service a loan to purchase each of the non-excluded ones of the plurality of real properties on offer.

30. A system defined by any one of the claims 18 to 29 wherein the processor interface comprises a processor-network interface.

31. A system defined by any one of the claims 16 to 30 wherein the purchaser is a real property investor.

32. A method defined by any one of the claims 1 to 15 wherein the purchaser is a real property investor.

33. A processor-readable tangible media including program instructions which when executed by a processor causes the processor to perform a method defined by any one of claims 1 to 15 and 32.

34. A computer program for instructing a processor, which when executed by the processor causes the processor to perform a method defined by any one of claims 1 to 15 and 32.
